(19) United States
(12) Patent Application Publication
(10) Pub. No.: US 2026/0134872 A1
(43) Pub. Date: May 14, 2026

(54) SIGNAL ENCODING AND DECODING METHOD AND APPARATUS, AND USER EQUIPMENT, NETWORK SIDE DEVICE AND STORAGE MEDIUM

(71) Applicant: Beijing Xiaomi Mobile Software Co., Ltd., Beijing (CN)

(72) Inventor: Shuo GAO, Beijing (CN)

(21) Appl. No.: 18/706,194

(22) PCT Filed: Nov. 2, 2021
(86) PCT No.: PCT/CN2021/128279

§ 371 Date: Apr. 30, 2024

(51) Int. Cl. G10L 19/02

(52) U.S. Cl. CPC G10L 19/02

(57) ABSTRACT

A signal encoding and decoding method is performed by an encoding end, and includes: obtaining an audio signal in a mixed format, wherein the audio signal in the mixed format includes at least one format of a channel-based audio signal, an object-based audio signal, or a scene-based audio signal; determining, based on signal characteristics of audio signals in different formats, an encoding mode of the audio signal in each format; and encoding the audio signal in each format using the encoding mode of the audio signal in each format to obtain encoded signal parameter information of the audio signal in each format, writing the encoded signal parameter information of the audio signal in each format into an encoded stream and sending the encoded stream to a decoding end.

### CROSS-REFERENCE TO RELATED APPLICATION

This application is a U.S. national phase of International Application No. PCT/CN2021/128279 filed on Nov. 2, 2021, the content of which is hereby incorporated by reference in its entirety.

### TECHNICAL FIELD

The disclosure relates to the field of communication technologies, in particular to a signal encoding and decoding method and apparatus, an encoding device, a decoding device and a storage medium.

### BACKGROUND

Since a 3D audio can enable users to have better stereoscopic perception and spatial immersion experience, the 3D audio has been widely used. When creating the end-to-end 3D audio experience, mixed-format audio signals are usually collected at an acquisition end, and the mixed-format audio signals may include, for example, at least two formats of a channel-based audio signal, an object-based audio signal, and a scene-based audio signal, and then the collected signals may be encoded and decoded, and finally rendered into binaural signals or multi-speaker signals according to a capability of a playback device (such as the terminal capability) for playback.

In the related art, a method for encoding a mixed-format audio signal may refer to processing each format by a corresponding encoding kernel, that is, the channel-based audio signal is processed using a channel signal encoding kernel, and the object-based audio signal is processed using an object signal encoding kernel, the scene-based audio signal is processed using a scene signal encoding kernel.

However, in the related art, when performing the encoding, parameter information such as the control information of the encoding end, the characteristic of the input mixed-format audio signal, the advantages and disadvantages of audio signals in different formats, and the actual playback requirement of the playback end are not considered, resulting in a low encoding efficiency for the mixed-format audio signal.

### SUMMARY

A first aspect of embodiments of the disclosure provides a signal encoding and decoding method, which is applied to an encoding end. The method includes:

obtaining an audio signal in a mixed format, in which the audio signal in the mixed format comprises at least one format of a channel-based audio signal, an object-based audio signal, and a scene-based audio signal;

determining, based on signal characteristics of audio signals in different formats, an encoding mode of the audio signal in each format; and

encoding the audio signal in each format using the encoding mode of the audio signal in each format to obtain encoded signal parameter information of the audio signal in each format, writing the encoded signal parameter information of the audio signal in each format into an encoded stream and sending the encoded stream to a decoding end.

A second aspect of the embodiments of the disclosure provides a signal encoding and decoding method, which is applied to a decoding end. The method includes:
receiving an encoded stream sent by an encoding end; and
decoding the encoded stream to obtain an audio signal in a mixed format, in which the audio signal in the mixed format comprises at least one format of a channel-based audio signal, an object-based audio signal, and a scene-based audio signal.

A third aspect of embodiments of the disclosure provides a communication apparatus. The communication apparatus includes: a processor and a memory storing a computer program. The processor is configured to perform the method described in the first aspect.

A fourth aspect of embodiments of the disclosure provides a communication apparatus. The communication apparatus includes: a processor and a memory storing a computer program. The processor is configured to perform the method described in the second aspect.

### BRIEF DESCRIPTION OF THE DRAWINGS

The above and/or additional aspects and advantages of the present disclosure will become apparent and understandable from the following description of the embodiments in combination with the accompanying drawings, in which:

FIG. 1a is a flowchart of an encoding and decoding method provided by an embodiment of the disclosure;

FIG. 1b is a schematic diagram of a collection layout of microphones of a collection end provided by an embodiment of the disclosure;

FIG. 1c is a schematic diagram of a playback layout of speakers of a playback end corresponding to FIG. 1b provided by an embodiment of the disclosure;

FIG. 2a is a flowchart of another encoding and decoding method provided by an embodiment of the disclosure;

FIG. 2b is a flowchart of a signal encoding method provided by an embodiment of the disclosure;

FIG. 3 is a flowchart of an encoding and decoding method provided by another embodiment of the disclosure;

FIG. 4a is a flowchart of an encoding and decoding method provided by another embodiment of the disclosure;

FIG. 4b is a flowchart of a signal encoding method for an object-based audio signal provided by an embodiment of the disclosure;

FIG. 5a is a flowchart of an encoding and decoding method provided by another embodiment of the disclosure;

FIG. 5b is a flowchart of another signal encoding method for an object-based audio signal provided by an embodiment of the disclosure;

FIG. 6a is a flowchart of an encoding and decoding method provided by another embodiment of the disclosure;

FIG. 6b is a flowchart of another signal encoding method for an object-based audio signal provided by an embodiment of the disclosure;

FIG. 7a is a flowchart of an encoding and decoding method provided by another embodiment of the disclosure;

FIG. 7b is a diagram of an algebraic codebook excited linear prediction (ACELP) encoding principle provided by another embodiment of the disclosure;

FIG. 7c is a diagram of a frequency domain encoding principle provided by another embodiment of the disclosure;

FIG. 7d is a flowchart of an encoding method for a second type of object signal set according to an embodiment of the disclosure;

FIG. 8a is a flowchart of an encoding and decoding method provided by another embodiment of the disclosure;

FIG. 8b is a flowchart of another encoding method for a second type of object signal set provided by an embodiment of the disclosure;

FIG. 9a is a flowchart of an encoding and decoding method provided by another embodiment of the disclosure;

FIG. 9b is a flowchart of another encoding method for a second type of object signal set provided by an embodiment of the disclosure;

FIG. 10 is a flowchart of an encoding and decoding method provided by another embodiment of the disclosure;

FIG. 11a is a flowchart of an encoding and decoding method provided by another embodiment of the disclosure;

FIG. 11b is a flowchart of a signal decoding method provided by an embodiment of the disclosure;

FIG. 12a is a flowchart of an encoding and decoding method provided by another embodiment of the disclosure;

FIGS. 12b, 12c to 12d are flowcharts of a decoding method for an object-based audio signal provided by an embodiment of the disclosure;

FIGS. 12e to 12f are flowcharts of a decoding method for a second type of object signal set provided by an embodiment of the disclosure;

FIG. 13 is a flowchart of an encoding and decoding method provided by another embodiment of the disclosure;

FIG. 14 is a flowchart of an encoding and decoding method provided by another embodiment of the disclosure;

FIG. 15 is a flowchart of an encoding and decoding method provided by another embodiment of the disclosure;

FIG. 16 is a flowchart of an encoding and decoding method provided by another embodiment of the disclosure;

FIG. 17 is a flowchart of an encoding and decoding method provided by another embodiment of the disclosure;

FIG. 18 is a block diagram of an encoding and decoding apparatus provided by an embodiment of the disclosure;

FIG. 19 is a block diagram of an encoding and decoding apparatus provided by another embodiment of the disclosure;

FIG. 20 is a block diagram of a user equipment provided by an embodiment of the disclosure; and

FIG. 21 is a block diagram of a network side device provided by an embodiment of the disclosure.

### DETAILED DESCRIPTION

The technical solutions in the embodiments of the disclosure will be clearly and completely described below with reference to the accompanying drawings in the embodiments of the disclosure. Obviously, the described embodiments are only examples of embodiments of the disclosure, and not all of the embodiments. Based on the embodiments in the disclosure, other embodiments obtained by those skilled in the art without inventive work fall within the scope of protection of this disclosure.

The terms used in the disclosure are only for the purpose of describing specific embodiments, and are not intended to limit the embodiments of the disclosure. The singular forms of “a” and “the” used in the disclosure and appended claims are also intended to include plural forms, unless the context clearly indicates other meanings. It should also be understood that the term “and/or” as used herein refers to and includes any or all possible combinations of one or more associated listed items.

It is understandable that although the terms “first”, “second”, and “third” may be used in the embodiments of the disclosure to describe various information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the term “if” as used herein can be interpreted as “when”, “while” or “in response to determining”.

The encoding and decoding method and apparatus, the user equipment, the network side device, and the storage medium provided by the embodiments of the present disclosure will be described in detail below with reference to the accompanying drawings.

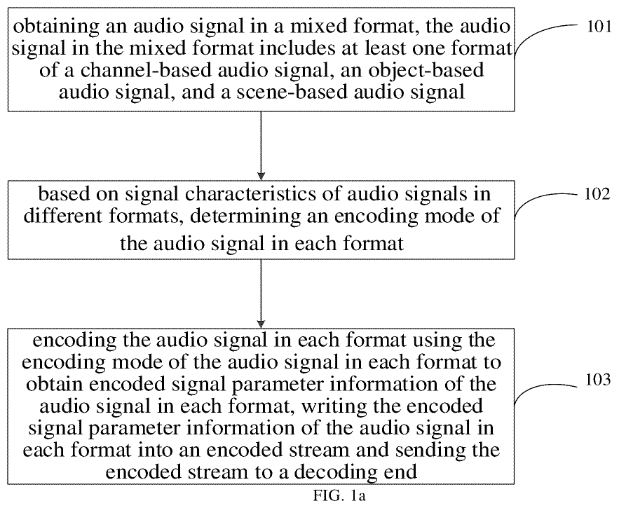

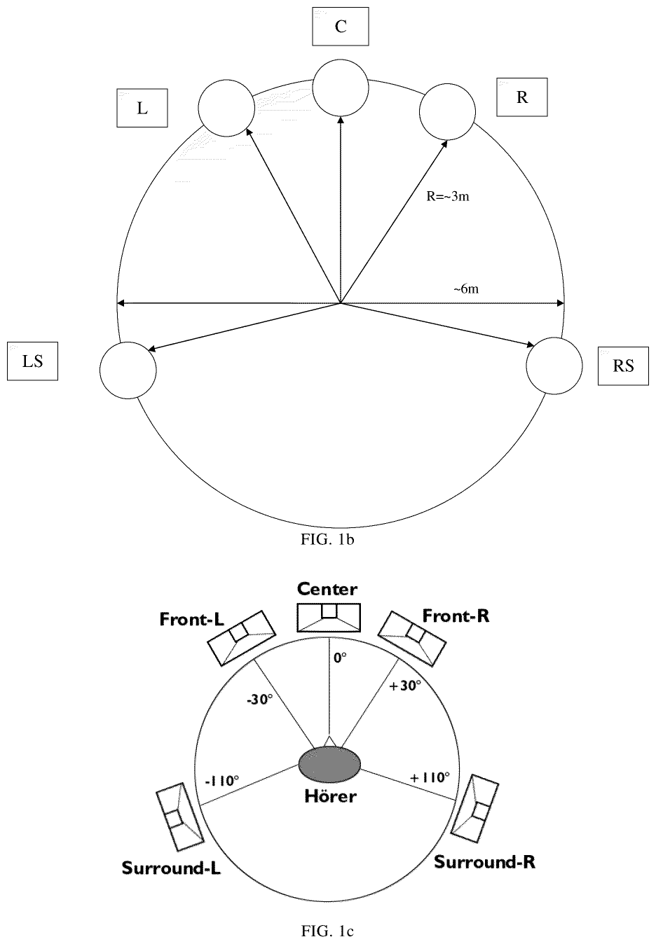

FIG. 1 is a flowchart of a signal encoding and decoding method according to an embodiment of the disclosure. The method is performed by an encoding end. As illustrated in FIG. 1, the signal encoding and decoding method may include the following steps.

At step 101, an audio signal in a mixed format is obtained. The audio signal in the mixed format includes at least one format of a channel-based audio signal, an object-based audio signal, and a scene-based audio signal.

In an embodiment of the disclosure, the encoding end may be a user equipment (UE, terminal device) or a base station, and the UE may be a device that provides voice and/or data connectivity to a user. The terminal device can communicate with one or more core networks via a radio access network (RAN). The UE can be an Internet of Things (IOT) terminal, such as a sensor device, a mobile phone (or called “cellular” phone) and a computer with the IoT terminal, for example, may be a fixed, portable, pocket, hand-held, built-in computer or vehicle-mounted device, for example, a station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the UE may also be a vehicle-mounted device, for example, may be a trip computer with a wireless communication function, or a wireless terminal connected externally to the trip computer. Alternatively, the UE may also be a roadside device, for example, may be a street lamp, a signal lamp, or other roadside devices with a wireless communication function.

In an embodiment of the present disclosure, the above-mentioned three formats of audio signals are specifically distinguished based on collection formats of signals, and the application scenarios of the audio signals in different formats will also be different.

Specifically, in an embodiment of the disclosure, a main application scenario of the above-mentioned channel-based audio signal may be a scenario in which collection layout of microphones and a playback layout of speakers that are the same are respectively pre-set at the collection end and the playback end. For example, FIG. 1b is a schematic diagram of the collection layout of microphones at the collection end provided by an embodiment of the disclosure, which can be used to collect channel-based audio signals in a 5.0 format. FIG. 1c is a schematic diagram of the playback layout of speakers at the playback end corresponding to FIG. 1b provided by an embodiment of the disclosure, which can play back the channel-based audio signals in the 5.0 format collected by the collection end in FIG. 1b.

In another embodiment of the disclosure, the above-mentioned object-based audio signal is typically obtained by performing sound recording on a sounding object using an independent microphone, and a main application scenario of the above-mentioned object-based audio signal may be a scenario in which independent control operations need to be performed on the audio signal at the playback end, such as sound switch, volume adjustment, sound image orientation adjustment, frequency band equalization processing and other control operations.

In another embodiment of the disclosure, a main application scenario of the above-mentioned scene-based audio signal may be a scenario in which a complete sound field where the collection end is located needs to be recorded, such as live recording of a concert, live recording of a football game, and the like.

At step 102, based on signal characteristics of audio signals in different formats, an encoding mode of the audio signal in each format is determined.

In an embodiment of the disclosure, the above-mentioned step “determining, based on signal characteristics of audio signals in different formats, an encoding mode of the audio signal in each format” may include: determining an encoding mode of the channel-based audio signal based on the signal characteristic of the channel-based audio signal; determining an encoding mode of the object-based audio signal based on the signal characteristic of the object-based audio signal; and determining an encoding mode of the scene-based audio signal based on the signal characteristic of the scene-based audio signal.

It should be noted that, in an embodiment of the disclosure, for the audio signals in different formats, methods for determining corresponding encoding modes based on the signal characteristics are different. The method for determining the encoding mode of the audio signal in each format based on the signal characteristic of the audio signal in each format will be described in detail in the following embodiments.

At step 103, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

In an embodiment of the disclosure, encoding the audio signal in each format using the encoding mode of the audio signal in each format to obtain the encoded signal parameter information of the audio signal in each format may include:
encoding the channel-based audio signal using the encoding mode of the channel-based audio signal;
encoding the object-based audio signal using the encoding mode of the object-based audio signal;
encoding the scene-based audio signal using the encoding mode of the scene-based audio signal.

Further, in an embodiment of the disclosure, when the encoded signal parameter information of the audio signals in various formats is written into the encoded stream, determined side information parameters corresponding to the audio signals in various formats may be written into the encoded stream. The side information parameter is configured to indicate an encoding mode corresponding to the audio signal in a corresponding format.

In an embodiment of the disclosure, by writing the side information parameters corresponding to the audio signals in various formats into the encoded stream and sending the encoded stream to the decoding end, the decoding end may determine the encoding code corresponding to the audio signal in each format based on the side information parameters corresponding to the audio signals in various formats, and may decode, based on the encoding mode, the audio signal in each format using a corresponding decoding mode subsequently.

It should be noted that, in an embodiment of the disclosure, for the object-based audio signal, the corresponding encoded signal parameter information may retain partial object signals. For the scene-based audio signal and the channel-based audio signal, the corresponding encoded signal parameter information does not need to retain the signal in the original format, but is converted to the signal in another format.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

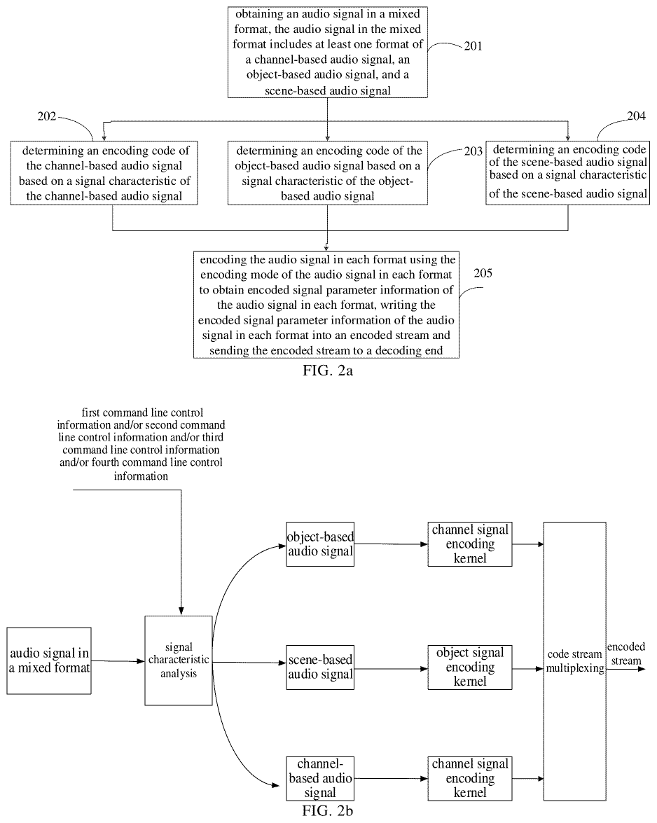

FIG. 2a is a flowchart of another signal encoding and decoding method according to an embodiment of the disclosure. The method is performed by an encoding end. As illustrated in FIG. 2a, the signal encoding and decoding method may include the following steps.

At step 201, an audio signal in a mixed format is obtained. The audio signal in the mixed format includes at least one format of a channel-based audio signal, an object-based audio signal, and a scene-based audio signal.

At step 202, in response to the audio signal in the mixed format including a channel-based audio signal, an encoding code of the channel-based audio signal is determined based on a signal characteristic of the channel-based audio signal.

In an embodiment of the disclosure, the method for determining the encoding mode of the channel-based audio signal based on the signal characteristic of the channel-based audio signal may include:

obtaining a number of object signals included in the channel-based audio signal and determining whether the number of the object signals included in the channel-based audio signal is less than a first threshold (for example, which may be 5).

In an embodiment of the disclosure, when the number of the object signals included in the channel-based audio signal is less than the first threshold, the method for determining the encoding mode of the channel-based audio signal may be at least one of the following solutions.

Solution 1, each object signal in the channel-based audio signal is encoded using the object signal encoding kernel.

Solution 2, input first command line control information is obtained, and the object signal encoding kernel is used to encode at least part of object signals in the channel-based audio signal based on the first command line control information. The first command line control information is configured to indicate object signals that need to be encoded among the object signals included in the channel-based audio signal. The number of the object signals that need to be encoded is greater than or equal to 1, and less than or equal to the total number of the object signals included in the channel-based audio signal.

It can be seen that, in an embodiment of the disclosure, when it is determined that the number of the object signals included in the channel-based audio signal is less than the first threshold, all or a part of the object signals in the channel-based audio signal may be encoded, so that the encoding difficulty can be greatly reduced and the encoding efficiency can be improved.

In another embodiment of the disclosure, when the number of the object signals included in the channel-based audio signal is not less than the first threshold, the method for determining the encoding mode of the channel-based audio signal may be at least one of the following solutions.

Solution 3, the channel-based audio signal is converted into a first audio signal in another format (for example, it may be a scene-based audio signal or an object-based audio signal). A number of channels of the first audio signal in another format is less than or equal to a number of channels of the channel-based audio signal. The encoding kernel corresponding to the first audio signal in another format is used to encode the first audio signal in another format. For example, in an embodiment of the disclosure, when the channel-based audio signal is a channel-based audio signal in the 7.1.4 format (the total number of channels is 13), the first audio signal in another format may be, for example, an FOA (First Order Ambisonics, also called first-order high-fidelity stereo) signal (the total number of channels is 4), then the total number of channels of the signal to be encoded can be changed from 13 to 4 by converting the channel-based audio signal in the 7.1.4 format into the FOA signal, thereby greatly reducing the encoding difficulty and improving the encoding efficiency.

Solution 4, input first command line control information is obtained, and the object signal encoding kernel is used to encode at least part of the object signals in the channel-based audio signal based on the first command line control information. The first command line control information is configured to indicate object signals that need to be encoded among the object signals included in the channel-based audio signal, the number of the object signals that need to be encoded is greater than or equal to 1, and less than or equal to the total number of the object signals included in the channel-based audio signal.

Solution 5, input second command line control information is obtained, and the object signal encoding kernel is used to encode at least part of channel signals in the channel-based audio signal based on the second command line control information. The second command line control information is configured to indicate channel signals that need to be encoded among the channel signals included in the channel-based audio signal, and the number of the channel signals that need to be encoded is greater than or equal to 1, and less than or equal to the total number of the channel signals included in the channel-based audio signal.

It can be seen that, in an embodiment of the disclosure, when it is determined that the number of the object signals included in the channel-based audio signal is large, if the channel-based audio signal is directly encoded, then the encoding complexity is high. In this case, only part of the object signals in the channel-based audio signal may be encoded, and/or only part of the channel signals in the channel-based audio signal may be encoded, and/or the channel-based audio signal may be converted into a signal with fewer channels for encoding, which can greatly reduce the encoding complexity and optimize the encoding efficiency.

At step 203, in response to the audio signal in the mixed format including an object-based audio signal, an encoding code of the object-based audio signal is determined based on a signal characteristic of the object-based audio signal.

Detailed description of step 203 may be introduced in the following embodiments.

At step 204, in response to the audio signal in the mixed format including a scene-based audio signal, an encoding code of the scene-based audio signal is determined based on a signal characteristic of the scene-based audio signal.

In an embodiment of the disclosure, determining the encoding mode of the scene-based audio signal based on the signal characteristic of the scene-based audio signal includes:

obtaining a number of object signals included in the scene-based audio signal and determining whether the number of the object signals included in the scene-based audio signal is less than a second threshold (for example, which may be 5).

In an embodiment of the disclosure, when the number of the object signals included in the scene-based audio signal is less than the second threshold, the method for determining the encoding mode of the scene-based audio signal may be at least one of the following solutions.

Solution a, each object signal in the scene-based audio signal is encoded using the object signal encoding kernel.

Solution b, input fourth command line control information is obtained, and the object signal encoding kernel is used to encode at least part of object signals in the scene-based audio signal based on the fourth command line control information. The fourth command line control information is configured to indicate object signals that need to be encoded among the object signals included in the scene-based audio signal. The number of the object signals that need to be encoded is greater than or equal to 1, and less than or equal to the total number of the object signals included in the scene-based audio signal.

It can be seen that, in an embodiment of the disclosure, when it is determined that the number of the object signals included in the scene-based audio signal is less than the second threshold, all or a part of the object signals in the scene-based audio signal may be encoded, so that the encoding difficulty can be greatly reduced and the encoding efficiency can be improved.

In another embodiment of the disclosure, when the number of the object signals included in the scene-based audio signal is not less than the second threshold, the method for determining the encoding mode of the scene-based audio signal may be at least one of the following solutions.

Solution c, the scene-based audio signal is converted into a second audio signal in another format. A number of channels of the second audio signal in another format is less than or equal to a number of channels of the scene-based audio signal. The scene signal encoding kernel is used to encode the second audio signal in another format.

Solution d, a low-order conversion is performed on the scene-based audio signal, so as to convert the scene-based audio signal into a scene-based audio signal with a lower order than a current order of the scene-based audio signal, and the scene signal encoding kernel is used to encode the scene-based audio signal with the lower order. It should be noted that, in an embodiment of the disclosure, when the low-order conversion is performed on the scene-based audio signal, the scene-based audio signal may also converted into a signal in another format through the low-order conversion. As an example, the 3rd-order scene-based audio signal can be converted into a low-order channel-based audio signal in a 5.0 format. In this case, the total number of channels of the signal to be encoded is changed from 16 ((3+1)*(3+1)) to 5, which greatly reduces the encoding complexity and improves the encoding efficiency.

It can be seen that, in an embodiment of the disclosure, when it is determined that the number of the object signals included in the scene-based audio signal is large, if the scene-based audio signal is directly encoded, the encoding complexity is high. In this case, the scene-based audio signal can be converted into a signal with a small number of channels before performing the encoding, and/or the scene-based audio signal can be converted into a low-order signal before performing the encoding, thereby greatly reducing the encoding complexity and optimizing the encoding efficiency.

At step 205, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

For the related description of step 205, reference may be made to the foregoing embodiments, which is not elaborated in the embodiment of the disclosure.

Finally, based on the above contents, FIG. 2b is a flowchart of a signal encoding method provided by an embodiment of the present disclosure. In combination with the above contents and FIG. 2b, it can be seen that when the encoding end receives an audio signal in a mixed format, the audio signals in various formats can be obtained by the signal characteristic analysis, and then, based on the command line control information (that is, the above-mentioned first command line control information, and/or the second command line control information (which will be introduced later), and/or the fourth command line control information), the corresponding encoding kernels are adopted to encode the audio signals in various formats using the corresponding encoding modes, and the encoded signal parameter information of the audio signals in various formats is written into the encoded stream and the encoded stream is sent to the decoding end.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

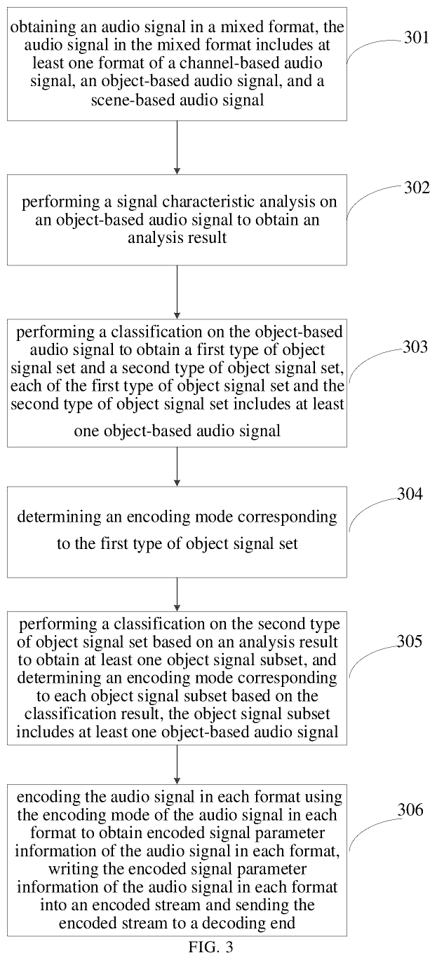

FIG. 3 is a flowchart of a signal encoding and decoding method provided by an embodiment of the present disclosure. The method is performed by an encoding end. As illustrated in FIG. 3, the signal encoding and decoding method may include the following steps.

At step 301, an audio signal in a mixed format is obtained. The audio signal in the mixed format includes at least one format of a channel-based audio signal, an object-based audio signal, and a scene-based audio signal.

At step 302, in response to the audio signal in the mixed format including an object-based audio signal, a signal characteristic analysis is performed on the object-based audio signal to obtain an analysis result.

In an embodiment of the disclosure, the signal characteristic analysis may be an analysis of cross-correlation parameter values of signals. In another embodiment of the disclosure, the characteristic analysis may be an analysis of a frequency-band bandwidth range of the signals. The analysis of the cross-correlation parameter values and the analysis of the frequency-band bandwidth range will be described in detail in following embodiments.

At step 303, a classification is performed on the object-based audio signal to obtain a first type of object signal set and a second type of object signal set. Each of the first type of object signal set and the second type of object signal set includes at least one object-based audio signal.

Since the object-based audio signal may include different types of object signals, and the subsequent encoding modes for different types of object signals will be different, in an embodiment of the disclosure, the different types of object signals in the object-based audio signal can be classified to obtain the first type of object signal set and the second type of object signal set, and then the corresponding encoding modes can be determined respectively for the first type of object signal set and the second type of object signal set. The classification manner for the first type of object signal set and the second type of object signal set will be described in detail in following embodiments.

At step 304, an encoding mode corresponding to the first type of object signal set is determined.

In an embodiment of the disclosure, when a different classification manner for the first type of object signal set is used in the above step 303, a different encoding mode of the first type of object signal set may be determined in this step. The specific method of “determining the encoding mode corresponding to the first type of object signal set” will be described in following embodiments.

At step 305, a classification is performed on the second type of object signal set based on the analysis result to obtain at least one object signal subset, and the encoding mode corresponding to each object signal subset is determined based on the classification result. The object signal subset includes at least one object-based audio signal.

If a different signal characteristic analysis is used in step 302, a different classification manner for the object based audio signal and a different method for determining the encoding mode corresponding to each object signal subset can be used in this step.

Specifically, in an embodiment of the disclosure, if the signal characteristic analysis used in step 302 is the analysis of the cross-correlation parameter values of the signals, then the classification manner for the second type of object signal set in this step can be a classification manner based on the cross-correlation parameter values of the signals, and the method for determining the encoding mode corresponding to each object signal subset may be determining the encoding mode corresponding to each object signal subset based on the cross-correlation parameter values of the signals.

In another embodiment of the disclosure, if the signal characteristic analysis used in step 302 is the analysis of the frequency-band bandwidth range of the signals, the classification manner for the second type of object signal set in this step may be a classification manner based on the frequency-band bandwidth range of the signals, and the method for determining the encoding mode corresponding to each object signal subset may be determining the encoding mode corresponding to each object signal subset based on the frequency-band bandwidth range of the signals.

The above-mentioned “the classification manner based on the cross-correlation parameter values of the signals or the frequency-band bandwidth range of the signals” and “determining the encoding mode corresponding to each object signal subset based on the cross-correlation parameter values of the signals or the frequency-band bandwidth range of the signals” will be described in detail in following embodiments.

At step 306, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

It should be noted that, in an embodiment of the disclosure, when a different classification manner for the second type of object signal set is used in step 307, the encoding situation of the above-mentioned second type of object signal subset may be different.

Accordingly, in an embodiment of the disclosure, the above-mentioned method for writing the encoded signal parameter information of the audio signal in each format into the encoded stream and sending the encoded stream to the decoding end may include the following steps.

Step 1, a classification side information parameter is determined. The classification side information parameter is configured to indicate the classification manner for the second type of object signal set.

Step 2, a side information parameter corresponding to the audio signal in each format is determined. The side information parameter is configured to indicate the encoding mode corresponding to the audio signal of the corresponding format.

Step 3, code stream multiplexing is performed on the classification side information parameter, the side information parameter corresponding to the audio signal in each format, and the encoded signal parameter information of the audio signal in each format, to obtain the encoded stream, and the encoded stream is sent to the decoding end.

In an embodiment of the disclosure, by sending the classification side information parameter and the side information parameters corresponding to the audio signals in various formats to the decoding end, the decoding end can determine the encoding situation corresponding to the object signal subset in the second type of object signal set based on the classification side information parameter, and the encoding mode corresponding to each object signal subset is determined based on the side information parameter corresponding to each object signal subset, so that based on the encoding situation and the encoding mode, the object-based audio signal can be subsequently decoded using the corresponding decoding mode and decoding mode, and the decoding end can also determine the encoding modes corresponding to the channel-based audio signal and the scene-based audio signal based on the side information parameter corresponding to the audio signal in each format, and then realize decoding of the channel-based audio signal and the scene-based audio signal.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

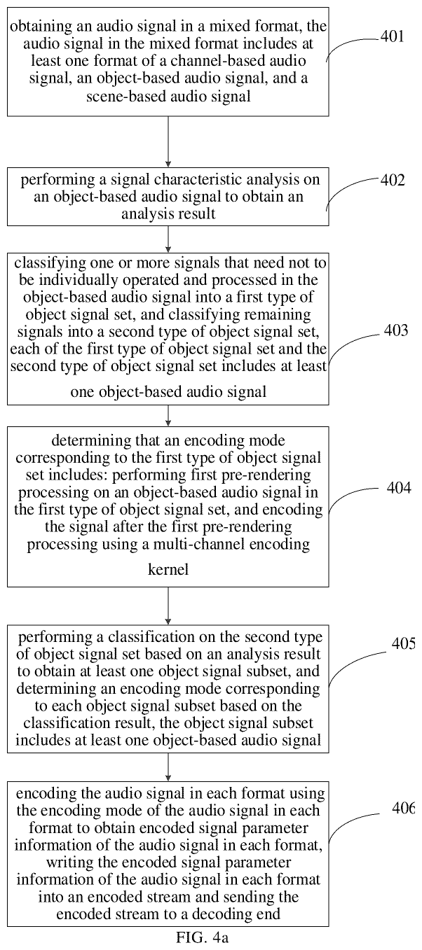

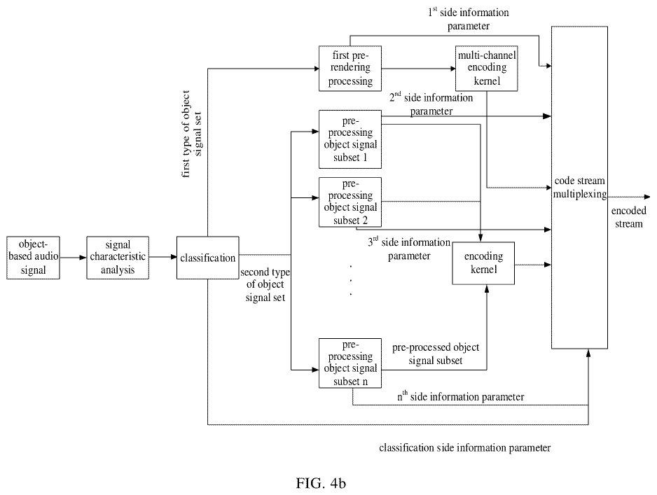

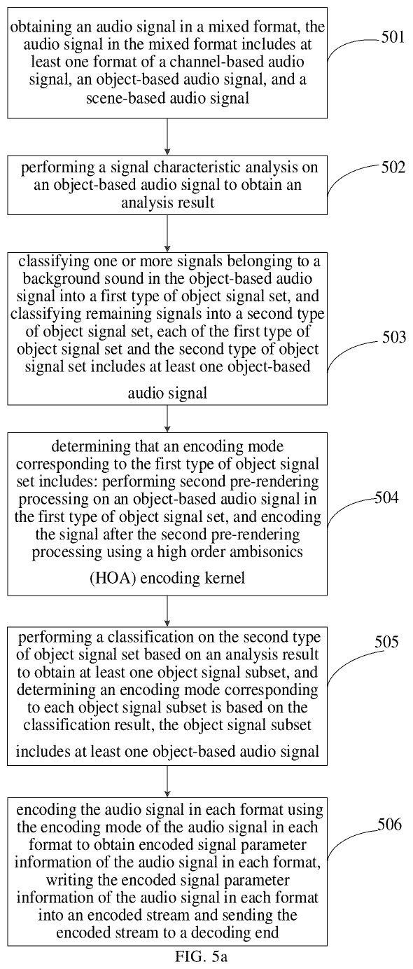

FIG. 4a is a flowchart of a signal encoding and decoding method provided by another embodiment of the present disclosure. The method is performed by an encoding end. As illustrated in FIG. 4a, the signal encoding and decoding method may include the following steps.

At step 401, an audio signal in a mixed format is obtained. The audio signal in the mixed format includes at least one format of a channel-based audio signal, an object-based audio signal, and a scene-based audio signal.

At step 402, in response to the audio signal in the mixed format including an object-based audio signal, a signal characteristic analysis is performed on the object-based audio signal to obtain an analysis result.

For the description of steps 401-402, reference may be made to the foregoing embodiments, which is not elaborated in the embodiment of the present disclosure.

At step 403, one or more signals that need not to be individually operated and processed in the object-based audio signal are classified into a first type of object signal set, and remaining signals are classified into a second type of object signal set. Each of the first type of object signal set and the second type of object signal set includes at least one object-based audio signal.

At step 404, it is determined that an encoding mode corresponding to the first type of object signal set includes: performing first pre-rendering processing on an object-based audio signal in the first type of object signal set, and encoding the signal after the first pre-rendering processing using a multi-channel encoding kernel.

In an embodiment of the disclosure, the first pre-rendering processing may include: performing signal format conversion processing on an object-based audio signal to convert the object-based audio signal into a channel-based audio signal.

At step 405, a classification is performed on the second type of object signal set based on an analysis result to obtain at least one object signal subset, and an encoding mode corresponding to each object signal subset is determined based on the classification result. The object signal subset includes at least one object-based audio signal.

At step 406, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

For the description of steps 405-406, reference may be made to the foregoing embodiments, which is not elaborated in the embodiment of the present disclosure.

Finally, based on the above contents, FIG. 4b is a flowchart of a signal encoding method for an object-based audio signal provided by an embodiment of the present disclosure. In combination with the above contents and FIG. 4b, a characteristic analysis can be performed on the object-based audio signal and then the classification is performed on the object-based audio signal to obtain the first type of object signal set and the second type of object signal set. The first pre-rendering processing is performed on the first type of object signal set, and the multi-channel encoding kernel is used for encoding. The classification is performed on the second type of object signal set based on the analysis result to obtain at least one object signal subset (such as object signal subset 1, object signal subset 2 . . . object signal subset n), and then the at least one object signal subset is encoded respectively.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

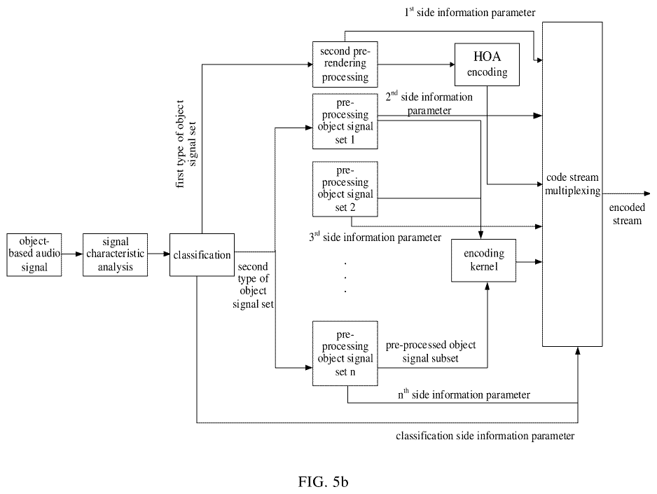

FIG. 5a is a flowchart of a signal encoding and decoding method provided by an embodiment of the present disclosure. The method is performed by an encoding end. As illustrated in FIG. 5a, the signal encoding and decoding method may include the following steps.

At step 501, an audio signal in a mixed format is obtained. The audio signal in the mixed format includes at least one format of a channel-based audio signal, an object-based audio signal, and a scene-based audio signal.

At step 502, in response to the audio signal in the mixed format including an object-based audio signal, a signal characteristic analysis is performed on the object-based audio signal to obtain an analysis result.

For the description of steps 501-502, reference may be made to the foregoing embodiments, which is not elaborated in the embodiment of the present disclosure.

At step 503, one or more signals belonging to a background sound in the object-based audio signal are classified into a first type of object signal set, and remaining signals are classified into a second type of object signal set. Each of the first type of object signal set and the second type of object signal set includes at least one object-based audio signal.

At step 504, it is determined that an encoding mode corresponding to the first type of object signal set includes: performing second pre-rendering processing on an object-based audio signal in the first type of object signal set, and encoding the signal after the second pre-rendering processing using a high order ambisonics (HOA) encoding kernel.

In an embodiment of the disclosure, the second pre-rendering processing may include: performing signal format conversion processing on an object-based audio signal to convert the object-based audio signal into a scene-based audio signal.

At step 505, a classification is performed on the second type of object signal set based on an analysis result to obtain at least one object signal subset, and an encoding mode corresponding to each object signal subset is determined based on the classification result. The object signal subset includes at least one object-based audio signal.

At step 506, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

For the description of steps 505-506, reference may be made to the foregoing embodiments, which is not elaborated in the embodiment of the present disclosure.

Finally, based on the above contents, FIG. 5b is a flowchart of another signal encoding method for an object-based audio signal provided by an embodiment of the present disclosure. In combination with the above contents and FIG. 5b, a characteristic analysis can be performed on the object-based audio signal and then the classification is performed on the object-based audio signal to obtain the first type of object signal set and the second type of object signal set. The second pre-rendering processing is performed on the first type of object signal set, and the HOA encoding kernel is used for encoding. The classification is performed on the second type of object signal set based on the analysis result to obtain at least one object signal subset (such as object signal subset 1, object signal subset 2 . . . object signal subset n), and then the at least one object signal subset is encoded respectively.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

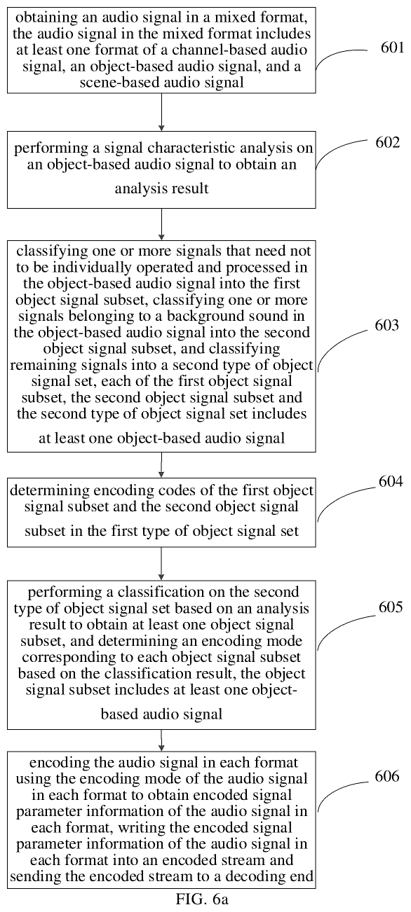

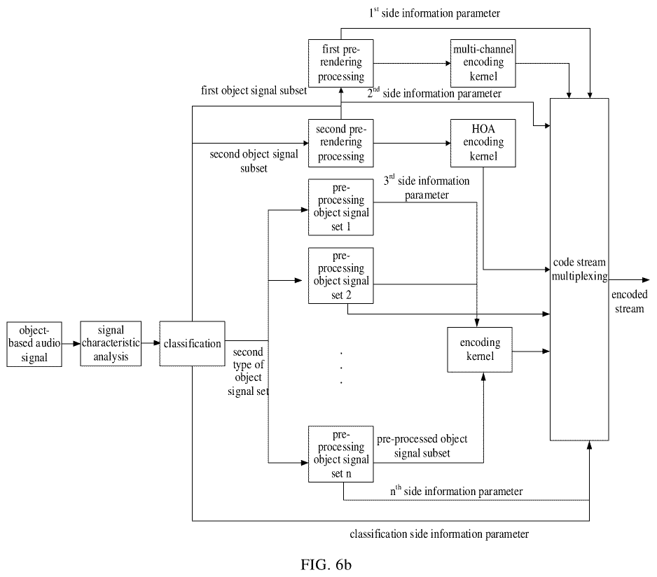

FIG. 6a is a flowchart of a signal encoding and decoding method provided by an embodiment of the present disclosure. The method is performed by an encoding end. The embodiment of FIG. 6a is different from the embodiments of FIG. 4a and FIG. 5a in that, in the embodiment, the first type of object signal set is further divided into a first object signal subset and a second object signal subset. As illustrated in FIG. 6a, the signal encoding and decoding method may include the following steps.

At step 601, an audio signal in a mixed format is obtained. The audio signal in the mixed format includes at least one format of a channel-based audio signal, an object-based audio signal, and a scene-based audio signal.

At step 602, a signal characteristic analysis is performed on an object-based audio signal to obtain an analysis result.

At step 603, one or more signals that need not to be individually operated and processed in the object-based audio signal are classified into the first object signal subset, one or more signals belonging to a background sound in the object-based audio signal are classified into the second object signal subset, and remaining signals are classified into a second type of object signal set. Each of the first object signal subset, the second object signal subset and the second type of object signal set includes at least one object-based audio signal.

At step 604, encoding codes of the first object signal subset and the second object signal subset in the first type of object signal set are determined.

In an embodiment of the disclosure, it is determined that the encoding mode corresponding to the first object signal subset in the first type of object signal set includes: performing first pre-rendering processing on an object-based audio signal in the first object signal subset, and encoding the signal after the first pre-rendering processing using a multi-channel encoding kernel. The first pre-rendering processing includes: performing signal format conversion processing on the object-based audio signal to convert it into a channel-based audio signal.

In an embodiment of the disclosure, it is determined that the encoding mode corresponding to the second object signal subset in the first type of object signal set includes: performing second pre-rendering processing on an object-based audio signal in the second object signal subset, and encoding the signal after the second pre-rendering processing using the HOA encoding kernel. The second pre-rendering processing includes: performing signal format conversion processing on the object-based audio signal to convert it into a scene-based audio signal.

At step 605, a classification is performed on the second type of object signal set based on an analysis result to obtain at least one object signal subset, and an encoding mode corresponding to each object signal subset is determined based on the classification result. The object signal subset includes at least one object-based audio signal.

At step 606, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

For the description of steps 601-606, reference may be made to the foregoing embodiments, which is not elaborated in the embodiment of the present disclosure.

Finally, based on the above contents, FIG. 6b is a flowchart of another signal encoding method for an object-based audio signal provided by an embodiment of the present disclosure. In combination with the above contents and FIG. 6b, a characteristic analysis can be performed on the object-based audio signal and then the classification is performed on the object-based audio signal to obtain a first type of object signal set and a second type of object signal set. The first type of object signal set includes a first object signal subset and a second object signal subset. The first pre-rendering processing is performed on the first type of object signal set, and the multi-channel encoding kernel is used for encoding. The second pre-rendering processing is performed on the second type of object signal set, and the HOA encoding kernel is used for encoding. The classification is performed on the second type of object signal set based on the analysis result to obtain at least one object signal subset (such as object signal subset 1, object signal subset 2 . . . object signal subset n), and then the at least one object signal subset is encoded respectively.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

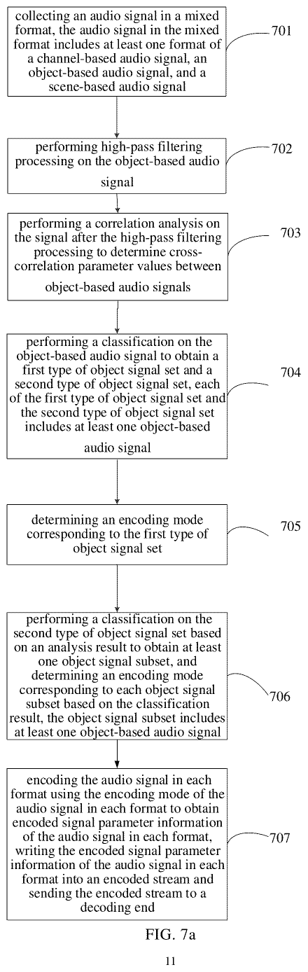

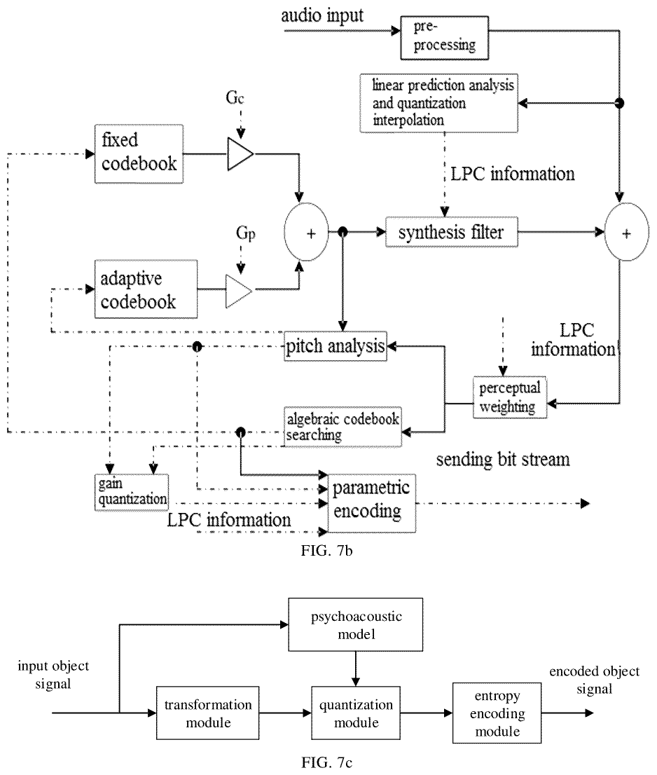

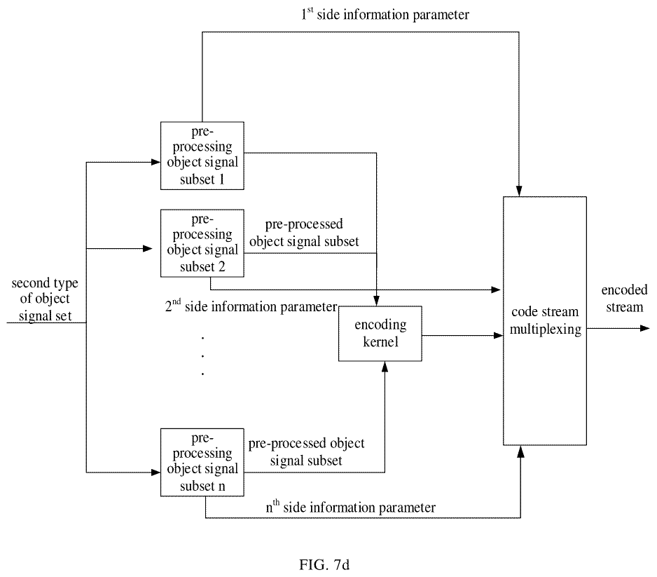

FIG. 7a is a flowchart of a signal encoding and decoding method provided by an embodiment of the present disclosure. The method is performed by an encoding end. As illustrated in FIG. 7a, the signal encoding and decoding method may include the following steps.

At step 701, an audio signal in a mixed format is obtained. The audio signal in the mixed format includes at least one format of a channel-based audio signal, an object-based audio signal, and a scene-based audio signal.

At step 702, in response to the audio signal in the mixed format including an object-based audio signal, high-pass filtering processing is performed on the object-based audio signal.

In an embodiment of the disclosure, a filter may be used to perform the high-pass filtering processing on the object signal.

A cut-off frequency of the filter is set to 20 Hz (Hertz). A filtering formula adopted by the filter can be expressed as the following formula (1):

$${H}_{20} ( Z ) = \frac{{b}_{0} + {b}_{1} {𝓏}^{- 1} + {b}_{2} {𝓏}^{- 2}}{1 + {a}_{1} {𝓏}^{- 1} + {a}_{2} {𝓏}^{- 2}} \qquad ( 1 )$$

where, a₁, a₂, b₀, b₁, and b₂ are all constants, for example, b₀=0.9981492, b₁=−1.9963008, b₂=0.9981498, a₁=1.9962990, a₂=−0.9963056.

At step 703, a correlation analysis is performed on the signal after the high-pass filtering processing to determine cross-correlation parameter values between object-based audio signals.

In an embodiment of the disclosure, the above-mentioned correlation analysis may be calculated using the following formula (2):

$${η}_{xy} = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} \qquad ( 2 )$$

η_{xy} is configured to indicate the cross-correlation parameter value of object-based audio signal X and object-based audio signal Y. Both Xᵢ and Yᵢ are configured to indicate the i-th object-based audio signal. X̅ is configured to indicate an average value of a signal sequence of the object-based audio signal X, Y̅ is configured to indicate an average value of a signal sequence of the object-based audio signal Y.

It should be noted that the above-mentioned method of “calculating the cross-correlation parameter value using the formula (2)” is an optional implementation provided by an embodiment of the present disclosure, and it should be recognized that other methods for calculating cross-correlation between parameter values between object signals in the related art can also be applied in the disclosure.

At step 704, a classification is performed on the object-based audio signal to obtain a first type of object signal set and a second type of object signal set. Each of the first type of object signal set and the second type of object signal set includes at least one object-based audio signal.

At step 705, an encoding mode corresponding to the first type of object signal set is determined.

For the description of steps 704-705, reference may be made to the foregoing embodiments, which is not elaborated in the embodiment of the present disclosure.

At step 706, a classification is performed on the second type of object signal set based on an analysis result to obtain at least one object signal subset, and an encoding mode corresponding to each object signal subset is determined based on the classification result. The object signal subset includes at least one object-based audio signal.

In an embodiment of the disclosure, performing the classification on the second type of object signal set to obtain at least one object signal subset and determining the encoding mode corresponding to each object signal subset based on the classification result includes:
setting a normalized correlation degree interval based on correlation degrees; and
performing the classification on the second type of object signal set based on the cross-correlation parameter values of the signals and the normalized correlation degree interval to obtain the at least one object signal subset.

Then the corresponding encoding mode can be determined based on a correlation degree corresponding to the object signal subset.

It can be understood that the number of the normalized correlation degree intervals is determined according to the division of the correlation degrees, which is not limited in the disclosure. Further, the lengths of different normalized correlation degree intervals are not limited in the disclosure. The corresponding number of normalized correlation degree intervals and different interval lengths can be set according to different divisions of the correlation degrees.

In an embodiment of the disclosure, the correlation degrees can be classified into four correlation degrees, including weak correlation, real correlation, significant correlation, and high correlation. Table 1 is a classification table for normalized correlation degree intervals provided by an embodiment of the disclosure.

TABLE 1

| normalized correlation degree interval | correlation degree |
|---|---|
| 0.00~±0.30 | weak correlation |
| ±0.30-±0.50 | real correlation |
| ±0.50-±0.80 | significant correlation |
| ±0.80-±1.00 | high correlation |

Based on the above contents, as an example, the object signals having the cross-correlation parameter values within the first interval are classified into an object signal set 1, and an independent encoding mode corresponding to the object signal set 1 is determined.

The object signals having the cross-correlation parameter values within the second interval are classified into an object signal set 2, and a joint encoding mode 1 corresponding to the object signal set 2 is determined.

The object signals having the cross-correlation parameter values within the third interval are classified into an object signal set 3, and a joint encoding mode 2 corresponding to the object signal set 3 is determined.

The object signals having the cross-correlation parameter values within the fourth interval are classified into an object signal set 4, and a joint encoding mode 3 corresponding to the object signal set 4 is determined.

In an embodiment of the disclosure, the first interval may be [0.00˜±0.30), the second interval may be [±0.30-±0.50), the third interval may be [±0.50-±0.80), and the fourth interval may be [±0.80-±1.00]. When the cross-correlation parameter value between the object signals is within the first interval, it means that the object signals are weakly correlated. In this case, in order to ensure the encoding accuracy, an independent encoding mode is used for encoding. When the cross-correlation parameter value between the object signals is within the second interval, the third interval, or the fourth interval, it means that the cross-correlation between the object signals is high, and in this case, a joint encoding mode can be used for encoding to ensure the compression rate to save bandwidth.

In an embodiment of the disclosure, the encoding mode corresponding to the object signal subset includes the independent encoding mode or the joint encoding mode.

In an embodiment of the disclosure, the independent encoding mode corresponds to a time-domain processing manner or a frequency-domain processing manner.

When an object signal in the object signal subset is a speech signal or a speech-like signal, the independent encoding mode adopts the time-domain processing manner.

When an object signal in the object signal subset is an audio signal in another format other than the speech signal or the speech-like signal, the independent encoding mode adopts the frequency-domain processing manner.

In an embodiment of the disclosure, the above-mentioned time-domain processing manner may be implemented by using an ACELP encoding model. FIG. 7b is a schematic diagram of an ACELP encoding principle provided by an embodiment of the present disclosure. For details about the ACELP encoder principle, reference can be made to the introduction in the prior art, which is not elaborated in the embodiment of the disclosure.

In an embodiment of the disclosure, the above-mentioned frequency-domain processing manner may include a transform domain processing manner. FIG. 7c is a schematic diagram of a frequency-domain encoding principle provided by an embodiment of the present disclosure. With reference to FIG. 7c, the input object signal can be converted to the frequency domain by performing MDCT transformation through a transformation module. A transformation formula and an inverse transformation formula of the MDCT transformation are expressed by the following formula (3) and formula (4) respectively.

$$X ( m ) = {\sum }_{k = 0}^{n - 1} f ( k ) x ( k ) cos ( \frac{π}{2 n} ( 2 k + 1 + \frac{n}{2} ) ( 2 m + 1 ) ) , for m = 0 … \frac{n}{2} - 1 \qquad ( 3 )$$

$$y ( p ) = f ( p ) \frac{4}{n} {\sum }_{m = 0}^{\frac{n}{2} - 1} X ( m ) cos ( \frac{π}{2 n} ( 2 p + 1 + \frac{n}{2} ) ( 2 m + 1 ) ) , for p = 0 … n - 1 \qquad ( 4 )$$

A psychoacoustic model is used to adjust each frequency band for the object signal which is transformed into the frequency domain, and a quantization module is used to quantize an envelope coefficient of each frequency band through bit allocation to obtain quantized parameters. Finally, an entropy encoding module is used to perform entropy encoding on the quantized parameters to output the encoded object signal.

At step 707, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

In an embodiment of the disclosure, encoding the audio signal in each format using the encoding mode of the audio signal in each format to obtain the encoded signal parameter information of the audio signal in each format may include:
encoding the channel-based audio signal using the encoding mode of the channel-based audio signal;
encoding the object-based audio signal using the encoding mode of the object-based audio signal;
encoding the scene-based audio signal using the encoding mode of the scene-based audio signal.

In an embodiment of the disclosure, the above method of encoding the object-based audio signal using the encoding mode of the object-based audio signal may include:
encoding one or more signals in the first type of object signal set using the encoding mode corresponding to the first type of object signal set;
performing preprocessing on one or more object signal subsets in the second type of object signal set, and encoding all the object signal subsets after the preprocessing in the second type of object signal set using respective encoding modes and using a same object signal encoding kernel.

Based on the above contents, FIG. 7d is a flowchart of an encoding method for the second type of object signal set provided in an embodiment of the present disclosure.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

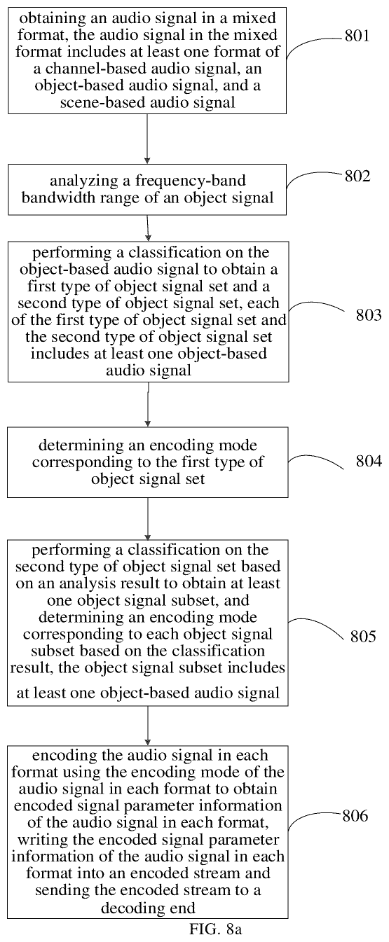

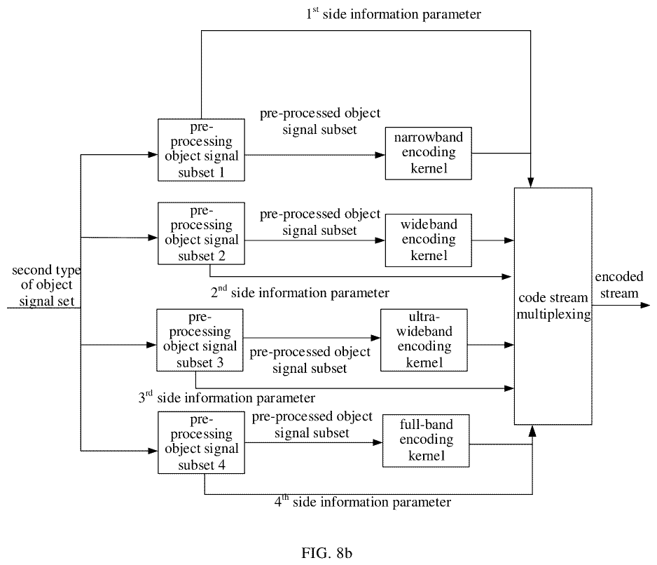

FIG. 8a is a flowchart of a signal encoding and decoding method according to an embodiment of the disclosure. The method is performed by an encoding end. As illustrated in FIG. 8a, the signal encoding and decoding method may include the following steps.

At step 801, an audio signal in a mixed format is obtained. The audio signal in the mixed format includes at least one format of a channel-based audio signal, an object-based audio signal, and a scene-based audio signal.

At step 802, in response to the audio signal in the mixed format including an object-based audio signal, a frequency-band bandwidth range of an object signal is analyzed.

At step 803, a classification is performed on the object-based audio signal to obtain a first type of object signal set and a second type of object signal set. Each of the first type of object signal set and the second type of object signal set includes at least one object-based audio signal.

At step 804, an encoding mode corresponding to the first type of object signal set is determined.

At step 805, a classification is performed on the second type of object signal set based on an analysis result to obtain at least one object signal subset, and an encoding mode corresponding to each object signal subset is determined based on the classification result. The object signal subset includes at least one object-based audio signal.

In an embodiment of the disclosure, performing the classification on the second type of object signal set based on the analysis result to obtain at least one object signal subset, and determining the encoding mode corresponding to each object signal subset based on the classification result may include:
determining bandwidth intervals corresponding to different frequency-band bandwidths;
performing the classification on the second type of object signal set to obtain the at least one object signal subset based on the frequency-band bandwidth range of the object signal and the bandwidth intervals corresponding to different frequency-band bandwidths, and determining a corresponding encoding mode based on a frequency-band bandwidth corresponding to the at least one object signal subset.

The frequency-band bandwidth of the signal usually includes narrowband, wideband, ultra-wideband and full-band. The bandwidth interval corresponding to the narrowband may be the first interval, the bandwidth interval corresponding to the wideband may be the second interval, the bandwidth interval corresponding to the ultra-wideband may be the third interval, and the bandwidth interval corresponding to the full band may be the fourth interval. Then, the classification can be performed on the second type of object signal set to obtain at least one object signal subset by determining the bandwidth interval to which the frequency-band bandwidth range of the object signal belongs. Afterwards, the corresponding encoding mode is determined according to the frequency-band bandwidth corresponding to at least one object signal subset. The narrowband, wideband, ultra-wideband and full-band correspond to the narrowband encoding mode, wideband encoding mode, ultra-wideband encoding mode and full-band encoding mode, respectively.

It should be noted that, the lengths of different bandwidth intervals are not limited in the embodiment of the disclosure, and bandwidth intervals between different frequency-band bandwidths may overlap.

As an example, the object signals having the frequency-band bandwidths within the first interval are classified into an object signal set 1, and the narrowband encoding mode corresponding to the object signal set 1 is determined.

The object signals having the frequency-band bandwidths within the second interval are classified into an object signal set 2, and the wideband encoding mode corresponding to the object signal set 2 is determined.

The object signals having the frequency-band bandwidths within the third interval are classified into an object signal set 3, and the ultra-wideband encoding mode corresponding to the object signal set 3 is determined.

The object signals having the frequency-band bandwidths within the fourth interval are classified into an object signal set 4, and the full band encoding mode corresponding to the object signal set 4 is determined.

In an embodiment of the disclosure, the first interval may be 0˜4 kHz, the second interval may be 0˜8 kHz, the third interval may be 0˜16 kHz, and the fourth interval may be 0˜20 kHz. When the frequency-band bandwidth of the object signal is within the first interval, it means that the object signal is a narrowband signal, and then it may be determined that the encoding mode corresponding to the object signal may include performing encoding using fewer bits (i.e., using the narrowband encoding mode). When frequency-band bandwidth of the object signal is within the second interval, it means that the object signal is a wideband signal, and then it may be determined that the encoding mode corresponding to the object signal may include performing encoding using more bits (i.e., using the wideband encoding mode). When the frequency-band bandwidth of the object signal is within the third interval, it means that the object signal is an ultra-wideband signal, and then it may be determined that the encoding mode corresponding to the object signal may include performing encoding using relative more bits (i.e., using the ultra-wideband encoding mode). When frequency-band bandwidth of the object signal is within the fourth interval, it means that the object signal is a full band signal, and then it may be determined that the encoding mode corresponding to the object signal may include performing encoding using much more bits (i.e., using the full band encoding mode).

By using different bits to encode the signal for different frequency-band bandwidth signals, the compression rate of the signal can be ensured and the bandwidth can be saved.

At step 806, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

In an embodiment of the disclosure, encoding the audio signal in each format using the encoding mode of the audio signal in each format to obtain the encoded signal parameter information of the audio signal in each format may include:
encoding the channel-based audio signal using the encoding mode of the channel-based audio signal;
encoding the object-based audio signal using the encoding mode of the object-based audio signal;
encoding the scene-based audio signal using the encoding mode of the scene-based audio signal.

In an embodiment of the disclosure, the above method of encoding the object-based audio signal using the encoding mode of the object-based audio signal may include:
encoding one or more signals in the first type of object signal set using the encoding mode corresponding to the first type of object signal set;
performing preprocessing on one or more object signal subsets in the second type of object signal set, and encoding different object signal subsets after the preprocessing using respective encoding modes and using different object signal encoding kernels.

Based on the above contents, FIG. 8b is a flowchart of an encoding method for the second type of object signal set provided in an embodiment of the present disclosure.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

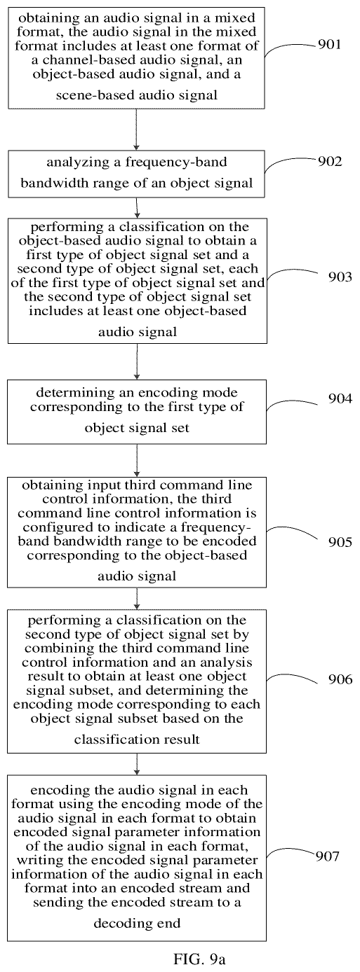

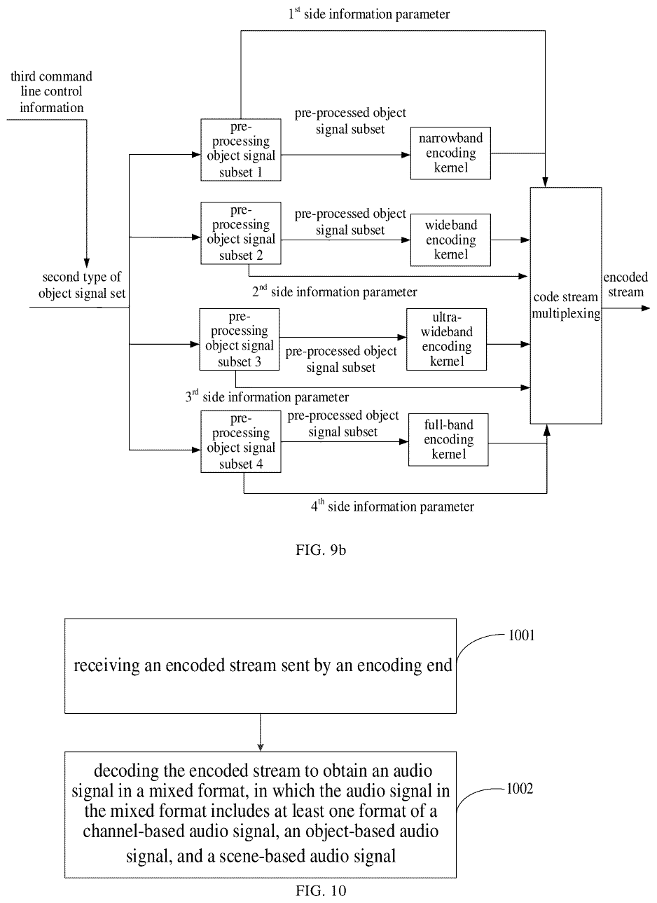

FIG. 9a is a flowchart of a signal encoding and decoding method according to an embodiment of the disclosure. The method is performed by an encoding end. As illustrated in FIG. 9a, the signal encoding and decoding method may include the following steps.

At step 901, an audio signal in a mixed format is obtained. The audio signal in the mixed format includes at least one format of a channel-based audio signal, an object-based audio signal, and a scene-based audio signal.

At step 902, in response to the audio signal in the mixed format including an object-based audio signal, a frequency-band bandwidth range of an object signal is analyzed.

At step 903, a classification is performed on the object-based audio signal to obtain a first type of object signal set and a second type of object signal set. Each of the first type of object signal set and the second type of object signal set includes at least one object-based audio signal.

At step 904, an encoding mode corresponding to the first type of object signal set is determined.

At step 905, input third command line control information is obtained. The third command line control information is configured to indicate a frequency-band bandwidth range to be encoded corresponding to the object-based audio signal.

At step 906, a classification is performed on the second type of object signal set by combining the third command line control information and an analysis result to obtain at least one object signal subset, and the encoding mode corresponding to each object signal subset is determined based on the classification result.

In an embodiment of the disclosure, performing the classification on the second type of object signal set by combining the third command line control information and the analysis result to obtain the at least one object signal subset, and determining the encoding mode corresponding to each object signal subset based on the classification result may include:
when a frequency-band bandwidth range indicated by the third command line control information is different from a frequency-band bandwidth range obtained from the analysis result, performing the classification on the second type of object signal set preferentially based on the frequency-band bandwidth range indicated by the third command line control information, and determining the encoding mode corresponding to each object signal set based on the classification result;
when a frequency-band bandwidth range indicated by the third command line control information is the same as a frequency-band bandwidth range obtained from the analysis result, performing the classification on the second type of object signal set based on the frequency-band bandwidth range indicated by the third command line control information and the frequency-band bandwidth range obtained from the analysis result, and determining the encoding mode corresponding to each object signal set based on the classification result.

In an embodiment of the disclosure, it is assumed that the analysis result of the object signal is an ultra-wideband signal, and the frequency-band bandwidth range indicated by the third command line control information of the object signal is a full band signal. In this case, the object signal can be classified into the object signal subset 4 based on the third command line control information, and it is determined that the encoding mode corresponding to the object signal subset 4 is the full band encoding mode.

At step 907, the audio signal in each format is encoded using the encoding mode of the audio signal in each format to obtain encoded signal parameter information of the audio signal in each format, the encoded signal parameter information of the audio signal in each format is written into an encoded stream and the encoded stream is sent to a decoding end.

In an embodiment of the disclosure, encoding the audio signal in each format using the encoding mode of the audio signal in each format to obtain the encoded signal parameter information of the audio signal in each format may include:
encoding the channel-based audio signal using the encoding mode of the channel-based audio signal;
encoding the object-based audio signal using the encoding mode of the object-based audio signal;
encoding the scene-based audio signal using the encoding mode of the scene-based audio signal.

In an embodiment of the disclosure, the above method of encoding the object-based audio signal using the encoding mode of the object-based audio signal may include:
encoding one or more signals in the first type of object signal set using the encoding mode corresponding to the first type of object signal set;
performing preprocessing on one or more object signal subsets in the second type of object signal set, and encoding different object signal subsets after the preprocessing using respective encoding modes and using different object signal encoding kernels.

Based on the above contents, FIG. 9b is a flowchart of another encoding method for the second type of object signal set provided in an embodiment of the present disclosure.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

FIG. 10 is a flowchart of a signal encoding and decoding method according to an embodiment of the disclosure. The method is performed by a decoding end. As illustrated in FIG. 10, the signal encoding and decoding method may include the following steps.

At step 1001, an encoded stream sent by an encoding end is received.

In an embodiment of the disclosure, the decoding end may be a UE or a base station.

At step 1002, the encoded stream is decoded to obtain an audio signal in a mixed format, in which the audio signal in the mixed format includes at least one format of a channel-based audio signal, an object-based audio signal, and a scene-based audio signal.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

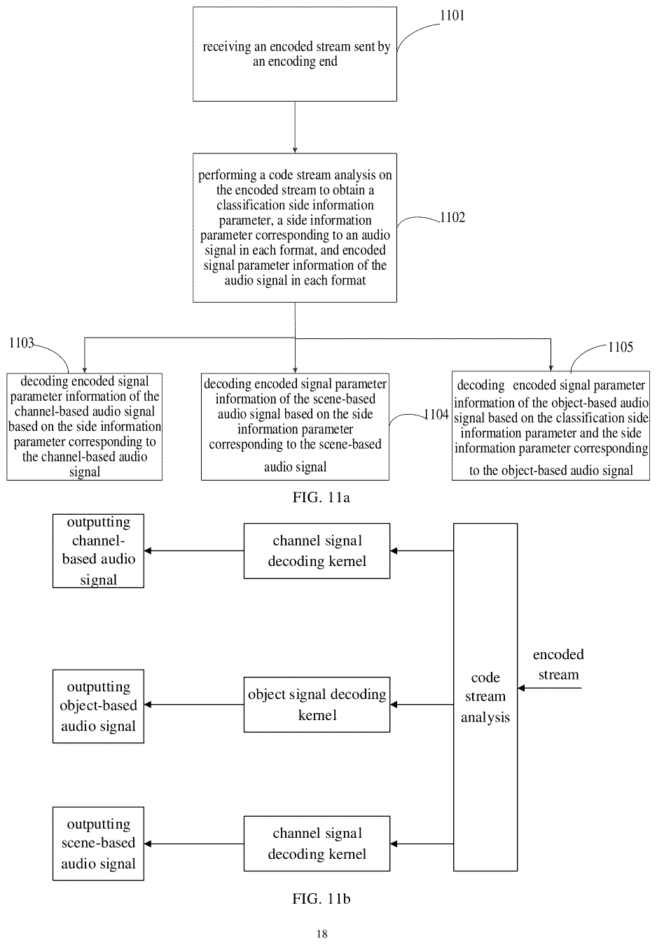

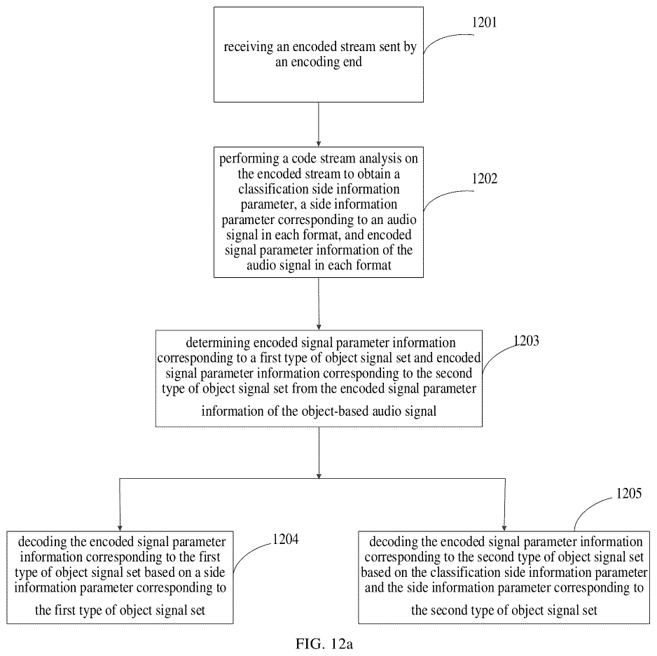

FIG. 11a is a flowchart of a signal encoding and decoding method according to an embodiment of the disclosure. The method is performed by a decoding end. As illustrated in FIG. 11a, the signal encoding and decoding method may include the following steps.

At step 1101, an encoded stream sent by an encoding end is received.

At step 1102, a code stream analysis is performed on the encoded stream to obtain a classification side information parameter, a side information parameter corresponding to an audio signal in each format, and encoded signal parameter information of the audio signal in each format.

The classification side information parameter is configured to indicate a classification manner for a second type of object signal set of the object-based audio signal. The side information parameter is configured to indicate an encoding mode corresponding to the audio signal in each format.

At step 1103, encoded signal parameter information of the channel-based audio signal is decoded based on the side information parameter corresponding to the channel-based audio signal.

In an embodiment of the disclosure, decoding the encoded signal parameter information of the channel-based audio signal based on the side information parameter corresponding to the channel-based audio signal may include: determining an encoding mode corresponding to the channel-based audio signal based on the side information parameter corresponding to the channel-based audio signal; and decoding the encoded signal parameter information of the channel-based audio signal using a corresponding decoding mode based on the encoding mode corresponding to the channel-based audio signal.

At step 1104, encoded signal parameter information of the scene-based audio signal is decoded based on the side information parameter corresponding to the scene-based audio signal.

In an embodiment of the disclosure, decoding the encoded signal parameter information of the scene-based audio signal based on the side information parameter corresponding to the scene-based audio signal may include: determining an encoding mode corresponding to the scene-based audio signal based on the side information parameter corresponding to the scene-based audio signal; and decoding the encoded signal parameter information of the scene-based audio signal using a corresponding decoding mode based on the encoding mode corresponding to the scene-based audio signal.

At step 1105, encoded signal parameter information of the object-based audio signal is decoded based on the classification side information parameter and the side information parameter corresponding to the object-based audio signal.

The detailed implementations of step 1105 will be described in the following embodiments.

Finally, based on the above contents, FIG. 11b is a flowchart of a signal decoding method provided in an embodiment of the present disclosure.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

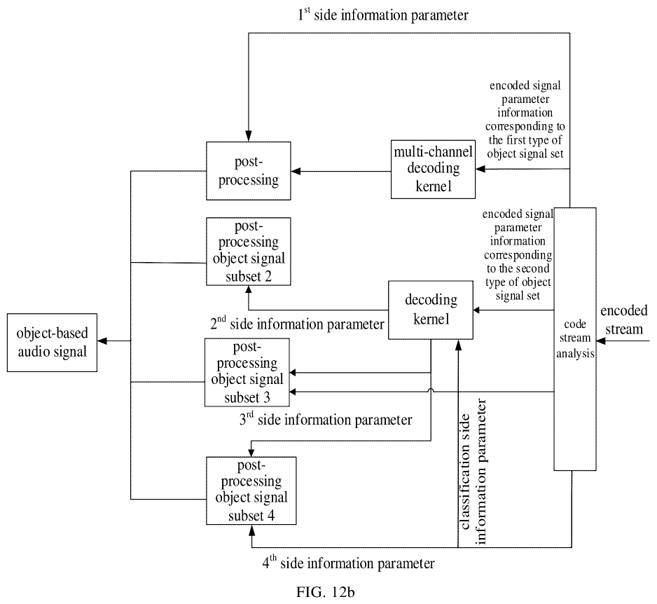

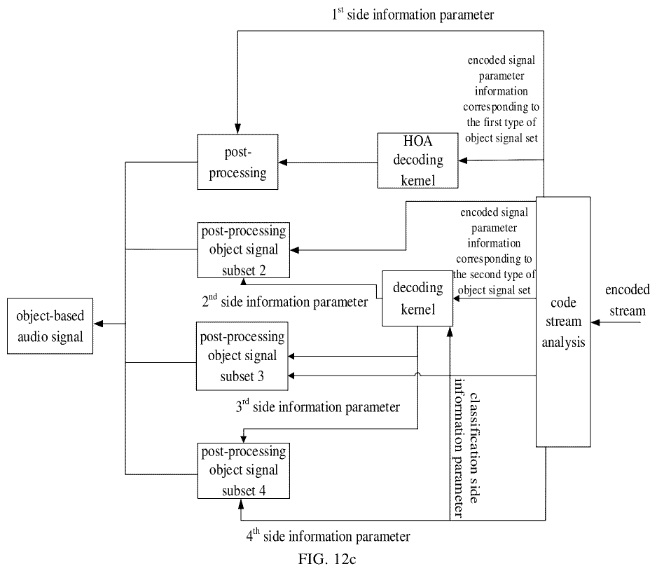

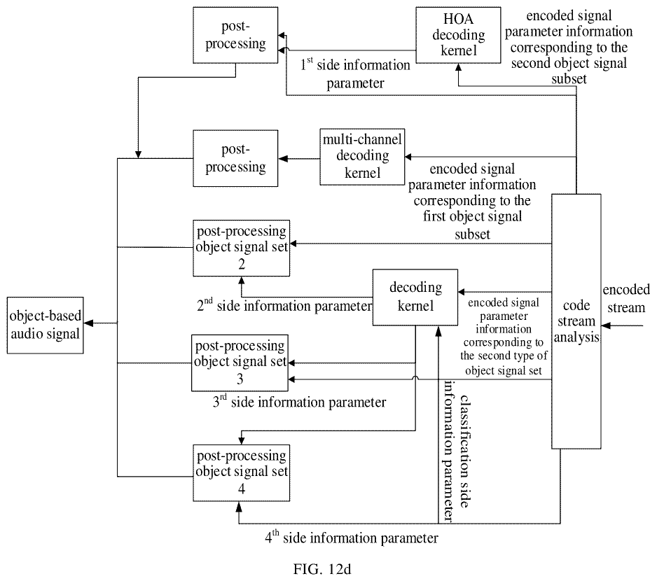

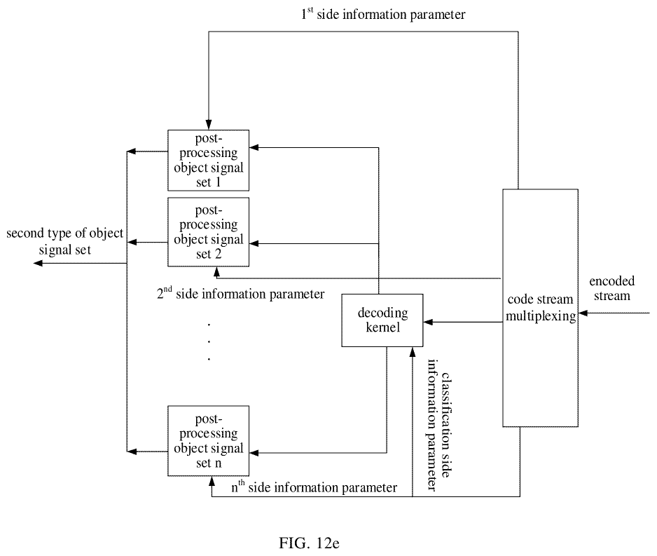

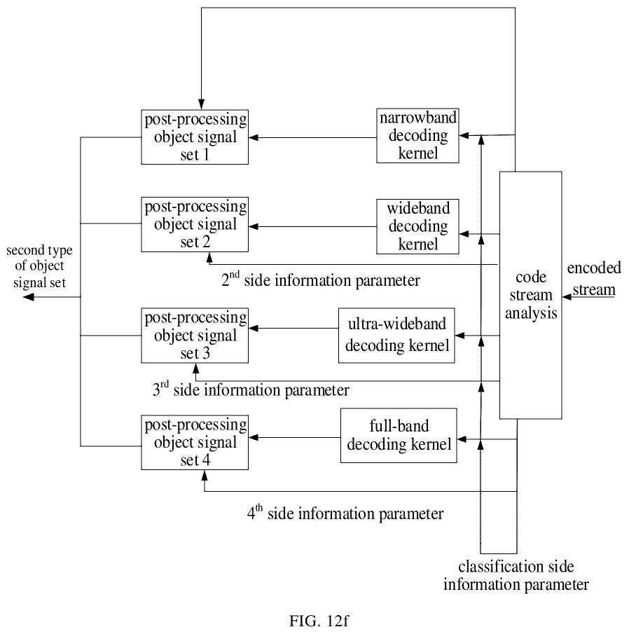

FIG. 12a is a flowchart of a signal encoding and decoding method according to an embodiment of the disclosure. The method is performed by a decoding end. As illustrated in FIG. 12a, the signal encoding and decoding method may include the following steps.

At step 1201, an encoded stream sent by an encoding end is received.

At step 1202, a code stream analysis is performed on the encoded stream to obtain a classification side information parameter, a side information parameter corresponding to an audio signal in each format, and encoded signal parameter information of the audio signal in each format.

At step 1203, encoded signal parameter information corresponding to a first type of object signal set and encoded signal parameter information corresponding to the second type of object signal set are determined from the encoded signal parameter information of the object-based audio signal.

In an embodiment of the disclosure, the encoded signal parameter information corresponding to the first type of object signal set and the encoded signal parameter information corresponding to the second type of object signal set are determined from the encoded signal parameter information of the object-based audio signal based on the side information parameter corresponding to the object-based audio signal.

At step 1204, the encoded signal parameter information corresponding to the first type of object signal set is decoded based on a side information parameter corresponding to the first type of object signal set.

In detail, in an embodiment of the disclosure, decoding the encoded signal parameter information corresponding to the first type of object signal set based on the side information parameter corresponding to the first type of object signal set may include: determining an encoding mode corresponding to the first type of object signal set based on the side information parameter corresponding to the first type of object signal set; and decoding the encoded signal parameter information of the first type of object signal set using a corresponding decoding mode based on the encoding mode corresponding to the first type of object signal set.

At step 1205, the encoded signal parameter information corresponding to the second type of object signal set is decoded based on the classification side information parameter and the side information parameter corresponding to the second type of object signal set.

In an embodiment of the disclosure, decoding the encoded signal parameter information corresponding to the second type of object signal set based on the classification side information parameter and the side information parameter corresponding to the second type of object signal set may include the following steps.

Step a, determining the classification manner for the second type of object signal set based on the classification side information parameter;

With reference to the above embodiments, for different classification manners for the second type of object signal set, the encoding conditions are different. In detail, in an embodiment of the disclosure, when the classification manner for the second type of object signal set is a classification manner based on cross-correlation parameter values of signals, the encoding situation corresponding to the encoding end includes encoding all object signal sets using respective encoding modes and using the same encoding kernel.

In another embodiment of the disclosure, when the classification manner for the second type of object signal set is a classification manner based on a frequency-band bandwidth range, the encoding situation corresponding to the encoding end includes encoding different object signal sets using respective encoding modes and using different encoding kernels.

Therefore, in this step, it is necessary to determine, based on the classification side information parameter, the classification manner for the second type of object signal set in the encoding process, so as to determine the encoding situation in the encoding process. Subsequently, the decoding can be performed based on the encoding situation.

Step b, the encoded signal parameter information corresponding to each object signal subset in the second type of object signal set is decoded based on the classification manner for the second type of object signal set and the side information parameter corresponding to the second type of object signal set.

In an embodiment of the disclosure, decoding the encoded signal parameter information corresponding to each object signal subset in the second type of object signal set based on the classification manner for the second type of object signal set and the side information parameter corresponding to the second type of object signal set may include:
determining the encoding situation in the encoding process based on the classification manner, and determining the corresponding decoding situation based on the encoding situation, and then according to the corresponding decoding situation and based on the encoding mode corresponding to the encoded signal parameter information corresponding to each object signal subset, using a corresponding decoding mode to decode the encoded signal parameter information corresponding to each object signal subset.

In detail, in an embodiment of the disclosure, if it is determined based on the classification side information parameter that the encoding situation in the encoding process includes: encoding all object signal subsets using the corresponding encoding modes and using the same encoding kernel, then it is determined that the decoding condition of the decoding process includes: decoding the encoded signal parameter information corresponding to all object signal subsets using the same decoding kernel. In the decoding process, the encoded signal parameter information corresponding to the object signal subset is decoded using a corresponding decoding mode based on the encoding mode corresponding to the encoded signal parameter information corresponding to each object signal subset.

In another embodiment of the disclosure, if it is determined based on the classification side information parameter that the encoding situation in the encoding process includes: encoding different object signal subsets using the corresponding encoding modes and using different encoding kernels, then it is determined that the decoding mode of the decoding process includes: decoding the encoded signal parameter information corresponding to each object signal subset using different decoding kernels. In the decoding process, specifically, the encoded signal parameter information corresponding to each object signal subset is decoded using a corresponding decoding mode based on the encoding mode corresponding to the encoded signal parameter information corresponding to each object signal subset.

Finally, based on the above contents, and FIGS. 12b, 12c and 12d are flowcharts of a decoding method for an object-based audio signal according to embodiments of the present disclosure. FIGS. 12e and 12f are flowcharts of a decoding method for a second type of object signal set provided by embodiments of the present disclosure.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

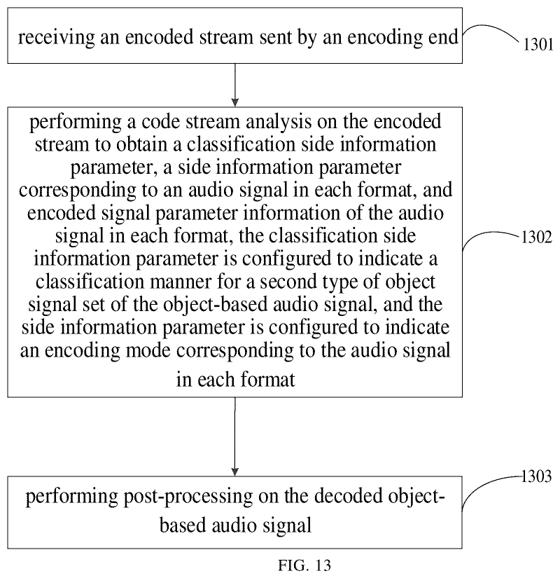

FIG. 13 is a flowchart of a signal encoding and decoding method according to an embodiment of the disclosure. The method is performed by a decoding end. As illustrated in FIG. 13, the signal encoding and decoding method may include the following steps.

At step 1301, an encoded stream sent by an encoding end is received.

At step 1302, the encoded stream is decoded to obtain an audio signal in a mixed format, in which the audio signal in the mixed format includes at least one format of a channel-based audio signal, an object-based audio signal, and a scene-based audio signal.

At step 1303, post-processing is performed on the decoded object-based audio signal.

In conclusion, in the signal encoding and decoding method provided in the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

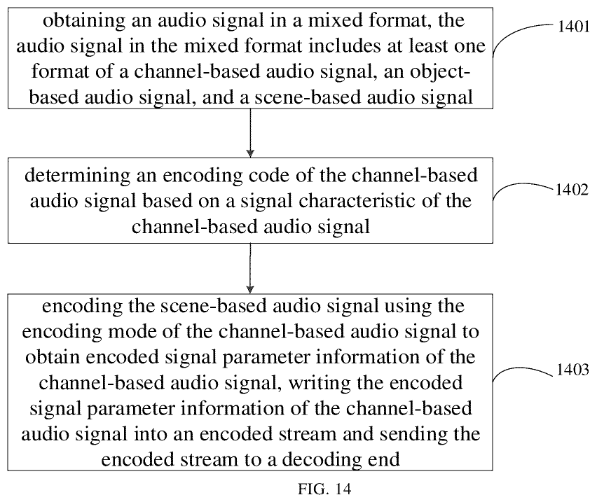

FIG. 14 is a flowchart of a signal encoding and decoding method according to an embodiment of the disclosure. The method is performed by an encoding end. As illustrated in FIG. 14, the signal encoding and decoding method may include the following steps.

At step 1401, an audio signal in a mixed format is obtained. The audio signal in the mixed format includes at least one format of a channel-based audio signal, an object-based audio signal, and a scene-based audio signal.

At step 1402, in response to the audio signal in the mixed format including a channel-based audio signal, an encoding code of the channel-based audio signal is determined based on a signal characteristic of the channel-based audio signal.

In an embodiment of the disclosure, the method for determining the encoding mode of the channel-based audio signal based on the signal characteristic of the channel-based audio signal may include:
obtaining a number of object signals included in the channel-based audio signal and determining whether the number of the object signals included in the channel-based audio signal is less than a first threshold (for example, which may be 5).

In an embodiment of the disclosure, when the number of the object signals included in the channel-based audio signal is less than the first threshold, the method for determining the encoding mode of the channel-based audio signal may be at least one of the following solutions.

Solution 1, each object signal in the channel-based audio signal is encoded using the object signal encoding kernel.

Solution 2, input first command line control information is obtained, and the object signal encoding kernel is used to encode at least part of object signals in the channel-based audio signal based on the first command line control information. The first command line control information is configured to indicate object signals that need to be encoded among the object signals included in the channel-based audio signal. The number of the object signals that need to be encoded is greater than or equal to 1, and less than or equal to the total number of the object signals included in the channel-based audio signal.

It can be seen that, in an embodiment of the disclosure, when it is determined that the number of the object signals included in the channel-based audio signal is less than the first threshold, all or a part of the object signals in the channel-based audio signal may be encoded, so that the encoding difficulty can be greatly reduced and the encoding efficiency can be improved.

In another embodiment of the disclosure, when the number of the object signals included in the channel-based audio signal is not less than the first threshold, the method for determining the encoding mode of the channel-based audio signal may be at least one of the following solutions.

Solution 3, the channel-based audio signal is converted into a first audio signal in another format (for example, it may be a scene-based audio signal or an object-based audio signal). A number of channels of the first audio signal in another format is less than or equal to a number of channels of the channel-based audio signal. The encoding kernel corresponding to the first audio signal in another format is used to encode the first audio signal in another format. For example, in an embodiment of the disclosure, when the channel-based audio signal is a channel-based audio signal in the 7.1.4 format (the total number of channels is 13), the first audio signal in another format may be, for example, an FOA (First Order Ambisonics, also called first-order high-fidelity stereo) signal (the total number of channels is 4), then the total number of channels of the signal to be encoded can be changed from 13 to 4 by converting the channel-based audio signal in the 7.1.4 format into the FOA signal, thereby greatly reducing the encoding difficulty and improving the encoding efficiency.

Solution 4, input first command line control information is obtained, and the object signal encoding kernel is used to encode at least part of the object signals in the channel-based audio signal based on the first command line control information. The first command line control information is configured to indicate object signals that need to be encoded among the object signals included in the channel-based audio signal, the number of the object signals that need to be encoded is greater than or equal to 1, and less than or equal to the total number of the object signals included in the channel-based audio signal.

Solution 5, input second command line control information is obtained, and the object signal encoding kernel is used to encode at least part of channel signals in the channel-based audio signal based on the second command line control information. The second command line control information is configured to indicate channel signals that need to be encoded among the channel signals included in the channel-based audio signal, and the number of the channel signals that need to be encoded is greater than or equal to 1, and less than or equal to the total number of the channel signals included in the channel-based audio signal.

It can be seen that, in an embodiment of the disclosure, when it is determined that the number of the object signals included in the channel-based audio signal is large, if the channel-based audio signal is directly encoded, then the encoding complexity is high. In this case, only part of the object signals in the channel-based audio signal may be encoded, and/or only part of the channel signals in the channel-based audio signal may be encoded, and/or the channel-based audio signal may be converted into a signal with fewer channels for encoding, which can greatly reduce the encoding complexity and optimize the encoding efficiency.

At step 1403, the channel-based audio signal is encoded using the encoding mode of the channel-based audio signal to obtain encoded signal parameter information of the channel-based audio signal, the encoded signal parameter information of the channel-based audio signal is written into an encoded stream and the encoded stream is sent to a decoding end.

For the related description of step 1403, reference may be made to the foregoing embodiments, which is not elaborated in the embodiment of the disclosure.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

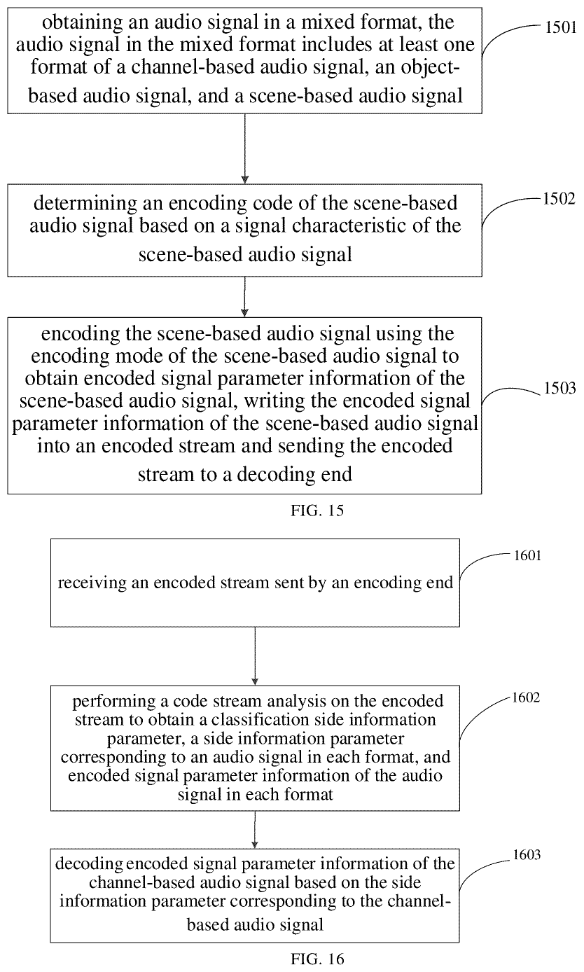

FIG. 15 is a flowchart of another signal encoding and decoding method according to an embodiment of the disclosure. The method is performed by an encoding end. As illustrated in FIG. 15, the signal encoding and decoding method may include the following steps.

At step 1501, an audio signal in a mixed format is obtained. The audio signal in the mixed format includes at least one format of a channel-based audio signal, an object-based audio signal, and a scene-based audio signal.

At step 1502, in response to the audio signal in the mixed format including a scene-based audio signal, an encoding code of the scene-based audio signal is determined based on a signal characteristic of the scene-based audio signal.

In an embodiment of the disclosure, the method for determining the encoding mode of the scene-based audio signal based on the signal characteristic of the scene-based audio signal may include:

obtaining a number of object signals included in the scene-based audio signal and determining whether the number of the object signals included in the scene-based audio signal is less than a second threshold (for example, which may be 5).

In an embodiment of the disclosure, when the number of the object signals included in the scene-based audio signal is less than the second threshold, the method for determining the encoding mode of the scene-based audio signal may be at least one of the following solutions.

Solution a, each object signal in the scene-based audio signal is encoded using the object signal encoding kernel.

Solution b, input fourth command line control information is obtained, and the object signal encoding kernel is used to encode at least part of object signals in the scene-based audio signal based on the fourth command line control information. The fourth command line control information is configured to indicate object signals that need to be encoded among the object signals included in the scene-based audio signal. The number of the object signals that need to be encoded is greater than or equal to 1, and less than or equal to the total number of the object signals included in the scene-based audio signal.

It can be seen that, in an embodiment of the disclosure, when it is determined that the number of the object signals included in the scene-based audio signal is less than the second threshold, all or a part of the object signals in the scene-based audio signal may be encoded, so that the encoding difficulty can be greatly reduced and the encoding efficiency can be improved.

In another embodiment of the disclosure, when the number of the object signals included in the scene-based audio signal is not less than the second threshold, the method for determining the encoding mode of the scene-based audio signal may be at least one of the following solutions.

Solution c, the scene-based audio signal is converted into a second audio signal in another format. A number of channels of the second audio signal in another format is less than or equal to a number of channels of the scene-based audio signal. The scene signal encoding kernel is used to encode the second audio signal in another format.

Solution d, a low-order conversion is performed on the scene-based audio signal, so as to convert the scene-based audio signal into a scene-based audio signal with a lower order than a current order of the scene-based audio signal, and the scene signal encoding kernel is used to encode the scene-based audio signal with the lower order. It should be noted that, in an embodiment of the disclosure, when the low-order conversion is performed on the scene-based audio signal, the scene-based audio signal may also converted into a signal in another format through the low-order conversion. As an example, the 3rd-order scene-based audio signal can be converted into a low-order channel-based audio signal in a 5.0 format. In this case, the total number of channels of the signal to be encoded is changed from 16 ((3+1)*(3+1)) to 5, which greatly reduces the encoding complexity and improves the encoding efficiency.

It can be seen that, in an embodiment of the disclosure, when it is determined that the number of the object signals included in the scene-based audio signal is large, if the scene-based audio signal is directly encoded, the encoding complexity is high. In this case, the scene-based audio signal can be converted into a signal with a small number of channels before performing the encoding, and/or the scene-based audio signal can be converted into a low-order signal before performing the encoding, thereby greatly reducing the encoding complexity and optimizing the encoding efficiency.

At step 1503, the scene-based audio signal is encoded using the encoding mode of the scene-based audio signal to obtain encoded signal parameter information of the scene-based audio signal, the encoded signal parameter information of the scene-based audio signal is written into an encoded stream and the encoded stream is sent to a decoding end.

For the related description of step 1503, reference may be made to the foregoing embodiments, which is not elaborated in the embodiment of the disclosure.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

FIG. 16 is a flowchart of a signal encoding and decoding method according to an embodiment of the disclosure. The method is performed by a decoding end. As illustrated in FIG. 16, the signal encoding and decoding method may include the following steps.

At step 1601, an encoded stream sent by an encoding end is received.

At step 1602, a code stream analysis is performed on the encoded stream to obtain a classification side information parameter, a side information parameter corresponding to an audio signal in each format, and encoded signal parameter information of the audio signal in each format.

At step 1603, encoded signal parameter information of the channel-based audio signal is decoded based on the side information parameter corresponding to the channel-based audio signal.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

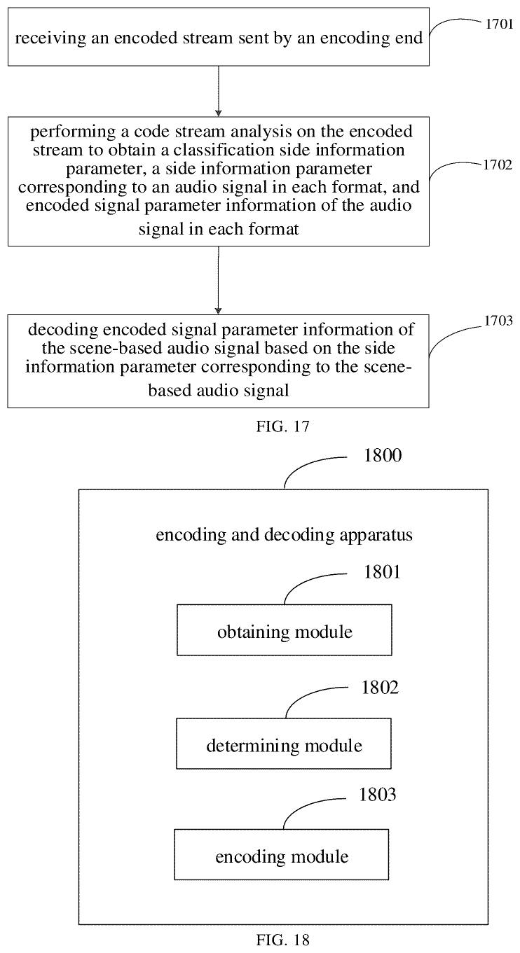

FIG. 17 is a flowchart of a signal encoding and decoding method according to an embodiment of the disclosure. The method is performed by a decoding end. As illustrated in FIG. 17, the signal encoding and decoding method may include the following steps.

At step 1701, an encoded stream sent by an encoding end is received.

At step 1702, a code stream analysis is performed on the encoded stream to obtain a classification side information parameter, a side information parameter corresponding to an audio signal in each format, and encoded signal parameter information of the audio signal in each format.

At step 1703, encoded signal parameter information of the scene-based audio signal is decoded based on the side information parameter corresponding to the scene-based audio signal.

In conclusion, in the signal encoding and decoding method provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

FIG. 18 is a block diagram of a signal encoding and decoding apparatus according to an embodiment of the disclosure. The apparatus is applied to an encoding end. As illustrated in FIG. 18, the apparatus may include:

an obtaining module 1801, configured to obtain an audio signal in a mixed format, in which the audio signal in the mixed format comprises at least one format of a channel-based audio signal, an object-based audio signal, and a scene-based audio signal;

a determining module 1802, configured to determine, based on signal characteristics of audio signals in different formats, an encoding mode of the audio signal in each format; and

an encoding module 1803, configured to encode the audio signal in each format using the encoding mode of the audio signal in each format to obtain encoded signal parameter information of the audio signal in each format, write the encoded signal parameter information of the audio signal in each format into an encoded stream and send the encoded stream to a decoding end.

In conclusion, in the signal encoding and decoding apparatus provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

Alternatively, in an embodiment of the disclosure, the determining module is further configured to:
determine an encoding mode of the channel-based audio signal based on a signal characteristic of the channel-based audio signal;
determine an encoding mode of the object-based audio signal based on a signal characteristic of the object-based audio signal; and
determine an encoding mode of the scene-based audio signal based on a signal characteristic of the scene-based audio signal.

Alternatively, in an embodiment of the disclosure, the determining module is further configured to:
obtain a number of object signals included in the channel-based audio signal;
determine whether the number of the object signals included in the channel-based audio signal is less than a first threshold;
in response to the number of the object signals included in the channel-based audio signal being less than the first threshold, determine that the encoding mode of the channel-based audio signal is at least one of:

encoding each object signal in the channel-based audio signal using an object signal encoding kernel;
obtaining input first command line control information, and encoding at least part of the object signals in the channel-based audio signal using the object signal encoding kernel based on the first command line control information, in which the first command line control information is configured to indicate object signals that need to be encoded among the object signals included in the channel-based audio signal, and a number of the object signals that need to be encoded is greater than or equal to 1 and less than the number of the object signals included in the channel-based audio signal.

Alternatively, in an embodiment of the disclosure, the determining module is further configured to:
obtain a number of object signals included in the channel-based audio signal;
determine whether the number of the object signals included in the channel-based audio signal is less than a first threshold;
in response to the number of the object signals included in the channel-based audio signal being not less than the first threshold, determine that the encoding mode of the channel-based audio signal is at least one of:

converting the channel-based audio signal into a first audio signal in another format, and encoding the first audio signal in another format using an encoding kernel corresponding to the first audio signal in another format, in which a number of channels of the first audio signal in another format is less than a number of channels of the channel-based audio signal;
obtaining input first command line control information, and encoding at least part of the object signals in the channel-based audio signal using an object signal encoding kernel based on the first command line control information, in which the first command line control information is configured to indicate object signals that need to be encoded among the object signals included in the channel-based audio signal, and a number of the object signals that need to be encoded is greater than or equal to 1 and less than the number of the object signals included in the channel-based audio signal;
obtaining input second command line control information, and encoding at least part of channel signals in the channel-based audio signal using the object signal encoding kernel based on the second command line control information, in which the second command line control information is configured to indicate channel signals that need to be encoded among the channel signals included in the channel-based audio signal, and a number of the channel signals that need to be encoded is greater than or equal to 1 and less than a number of the channel signals included in the channel-based audio signal.

Alternatively, in an embodiment of the disclosure, the encoding module is further configured to:
encode the channel-based audio signal using the encoding mode of the channel-based audio signal.

Alternatively, in an embodiment of the disclosure, the determining module is further configured to:
perform a signal characteristic analysis on the object-based audio signal to obtain an analysis result;
perform a classification on the object-based audio signal to obtain a first type of object signal set and a second type of object signal set, in which each of the first type of object signal set and the second type of object signal set includes at least one object-based audio signal;
determine an encoding mode corresponding to the first type of object signal set; and
perform a classification on the second type of object signal set based on the analysis result to obtain at least one object signal subset, and determining an encoding mode corresponding to each object signal subset based on a classification result, in which the object signal subset includes at least one object-based audio signal.

Alternatively, in an embodiment of the disclosure, the determining module is further configured to:
classify one or more signals that need not to be individually operated and processed in the object-based audio signal into the first type of object signal set, and classifying remaining signals into the second type of object signal set.

Alternatively, in an embodiment of the disclosure, the determining module is further configured to:
determine that the encoding mode corresponding to the first type of object signal set includes: performing first pre-rendering processing on an object-based audio signal in the first type of object signal set, and encoding the signal after the first pre-rendering processing using a multi-channel encoding kernel.

The first pre-rendering processing includes: performing signal format conversion processing on an object-based audio signal to convert the object-based audio signal into a channel-based audio signal.

Alternatively, in an embodiment of the disclosure, the determining module is further configured to:
classify one or more signals belonging to a background sound in the object-based audio signal into the first type of object signal set, and classify remaining signals into the second type of object signal set.

Alternatively, in an embodiment of the disclosure, the determining module is further configured to:
determine that the encoding mode corresponding to the first type of object signal set includes: performing second pre-rendering processing on an object-based audio signal in the first type of object signal set, and encoding the signal after the second pre-rendering processing using a high order ambisonics (HOA) encoding kernel.

The second pre-rendering processing comprises: performing signal format conversion processing on an object-based audio signal to convert the object-based audio signal into a scene-based audio signal.

Alternatively, in an embodiment of the disclosure, the determining module is further configured to:
classify one or more signals that need not to be individually operated and processed in the object-based audio signal into the first object signal subset, classify one or more signals belonging to a background sound in the object-based audio signal into the second object signal subset, and classify remaining signals into the second type of object signal set.

Alternatively, in an embodiment of the disclosure, the determining module is further configured to:
determine that an encoding mode corresponding to the first object signal subset in the first type of object signal set includes: performing first pre-rendering processing on an object-based audio signal in the first object signal subset, and encoding the signal after the first pre-rendering processing using a multi-channel encoding kernel; in which the first pre-rendering processing includes: performing signal format conversion processing on an object-based audio signal to convert the object-based audio signal into a channel-based audio signal; and
determine that an encoding mode corresponding to the second object signal subset in the first type of object signal set includes: performing second pre-rendering processing on an object-based audio signal in the second object signal subset, and encoding the signal after the second pre-rendering processing using an HOA encoding kernel; in which the second pre-rendering processing includes: performing signal format conversion processing on an object-based audio signal to convert the object-based audio signal into a scene-based audio signal.

Alternatively, in an embodiment of the disclosure, the determining module is further configured to:
perform high-pass filtering processing on object-based audio signals; and
perform a correlation analysis on the signals after the high-pass filtering processing to determine cross-correlation parameter values between the object-based audio signals.

Alternatively, in an embodiment of the disclosure, the determining module is further configured to:
set a normalized correlation degree interval based on correlation degrees; and
perform the classification on the second type of object signal set based on the cross-correlation parameter values of the object-based audio signals and the normalized correlation degree interval to obtain the at least one object signal subset, and determine the corresponding encoding mode based on a correlation degree corresponding to the at least one object signal subset.

Alternatively, in an embodiment of the disclosure, the encoding mode corresponding to the object signal subset includes an independent encoding mode or a joint encoding mode.

Alternatively, in an embodiment of the disclosure, the independent encoding mode corresponds to a time-domain processing manner or a frequency-domain processing manner.

In response to an object signal in the object signal subset being a speech signal or a speech-like signal, the independent encoding mode adopts the time-domain processing manner.

In response to an object signal in the object signal subset being an audio signal in another format other than the speech signal or the speech-like signal, the independent encoding mode adopts the frequency-domain processing manner.

Alternatively, in an embodiment of the disclosure, the encoding module is further configured to:
encode the object-based audio signal using the encoding mode of the object-based audio signal;
in which encoding the object-based audio signal using the encoding mode of the object-based audio signal includes:
encoding one or more signals in the first type of object signal set using an encoding mode corresponding to the first type of object signal set;
performing preprocessing on one or more object signal subsets in the second type of object signal set, and encoding all the object signal subsets after the preprocessing in the second type of object signal set using respective encoding modes and using a same object signal encoding kernel.

Alternatively, in an embodiment of the disclosure, the determining module is further configured to:
analyze a frequency-band bandwidth range of the object signal.

Alternatively, in an embodiment of the disclosure, the determining module is further configured to:
determine bandwidth intervals corresponding to different frequency-band bandwidths;
perform the classification on the second type of object signal set to obtain the at least one object signal subset based on the frequency-band bandwidth range of the object-based audio signal and the bandwidth intervals corresponding to different frequency-band bandwidths, and determine a corresponding encoding mode based on a frequency-band bandwidth corresponding to the at least one object signal subset.

Alternatively, in an embodiment of the disclosure, the determining module is further configured to:
obtain input third command line control information, in which the third command line control information is configured to indicate a frequency-band bandwidth range to be encoded corresponding to the object-based audio signal;
perform the classification on the second type of object signal set by combining the third command line control information and the analysis result to obtain the at least one object signal subset, and determine the encoding mode corresponding to each object signal subset based on the classification result.

Alternatively, in an embodiment of the disclosure, the encoding module is further configured to:
encode the object-based audio signal using the encoding mode of the object-based audio signal;
in which encoding the object-based audio signal using the encoding mode of the object-based audio signal includes:
encoding one or more signals in the first type of object signal set using the encoding mode corresponding to the first type of object signal set;
performing preprocessing on object signal subsets in the second type of object signal set, and encoding different object signal subsets after the preprocessing using respective encoding modes and using different object signal encoding kernels.

Alternatively, in an embodiment of the disclosure, the determining module is further configured to:
obtain a number of object signals included in the scene-based audio signal;
determine whether the number of the object signals included in the scene-based audio signal is less than a second threshold;
in response to the number of the object signals included in the scene-based audio signal being less than the second threshold, determine that the encoding mode of the scene-based audio signal is at least one of:
encoding each object signal in the scene-based audio signal using an object signal encoding kernel;
obtaining input fourth command line control information, and encoding at least part of the object signals in the scene-based audio signal using the object signal encoding kernel based on the fourth command line control information, in which the fourth command line control information is configured to indicate object signals that need to be encoded among the object signals included in the scene-based audio signal, and a number of the object signals that need to be encoded is greater than or equal to 1 and less than the number of the object signals included in the scene-based audio signal.

Alternatively, in an embodiment of the disclosure, the determining module is further configured to:
obtain a number of object signals included in the scene-based audio signal;
determine whether the number of the object signals included in the scene-based audio signal is less than a second threshold;
in response to the number of the object signals included in the scene-based audio signal being not less than the second threshold, determine that the encoding mode of the scene-based audio signal is at least one of:
convert the scene-based audio signal into a second audio signal in another format, and encode the second audio signal in another format using a scene signal encoding kernel, in which a number of channels of the second audio signal in another format is smaller than a number of channels of the scene-based audio signal;
perform a low-order conversion on the scene-based audio signal to covert the scene-based audio signal to a scene-based audio signal with a lower order than a current order of the scene-based audio signal, and encode the scene-based audio signal with the lower order using the scene signal encoding kernel.

Alternatively, in an embodiment of the disclosure, the encoding module is further configured to:
encode the scene-based audio signal using the encoding mode of the scene-based audio signal.

Alternatively, in an embodiment of the disclosure, the encoding module is further configured to:
determine a classification side information parameter, in which the classification side information parameter is configured to indicate a classification manner for the second type of object signal set;
determine a side information parameter corresponding to the audio signal in each format, in which the side information parameter is configured to indicate the encoding mode corresponding to the audio signal in each format;
perform code stream multiplexing on the classification side information parameter, the side information parameter corresponding to the audio signal in each format, and the encoded signal parameter information of the audio signal in each format to obtain the encoded stream, and send the encoded stream to the decoding end.

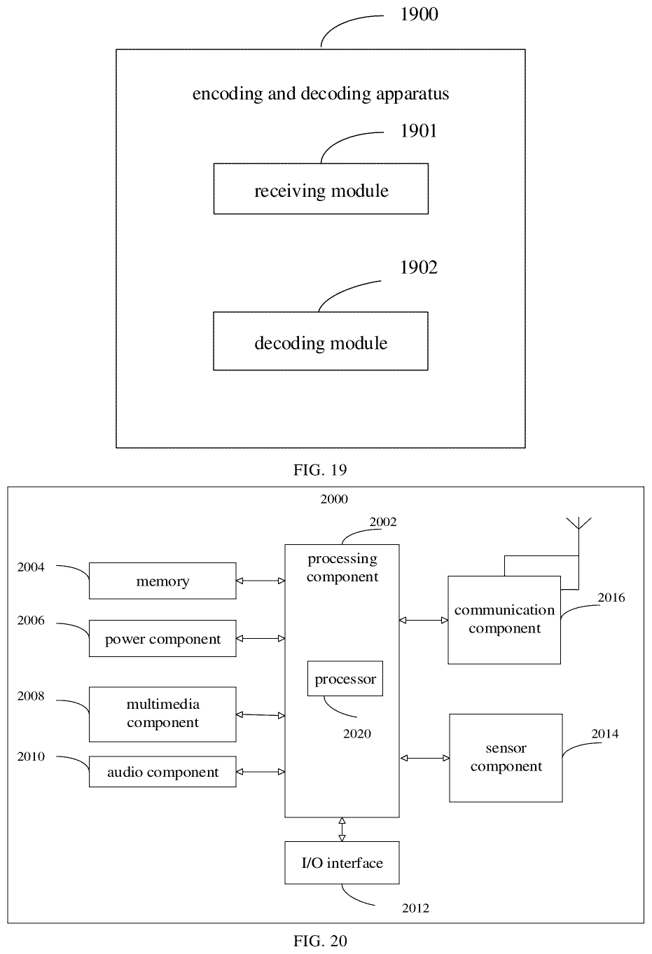

FIG. 19 is a block diagram of a signal encoding and decoding apparatus according to an embodiment of the disclosure. The apparatus is applied to a decoding end. As illustrated in FIG. 19, the apparatus may include:
a receiving module 1901, configured to receive an encoded stream sent by an encoding end;
a decoding module 1902, configured to decode the encoded stream to obtain an audio signal in a mixed format, in which the audio signal in the mixed format comprises at least one format of a channel-based audio signal, an object-based audio signal, and a scene-based audio signal.

In conclusion, in the signal encoding and decoding apparatus provided by the embodiment of the disclosure, firstly, the audio signal in the mixed format is obtained, and the audio signal in the mixed format includes at least one format of the channel-based audio signal, the object-based audio signal, and the scene-based audio signal. The encoding mode of the audio signal in each format is determined based on signal characteristics of the audio signals in different formats. The audio signal in each format is encoded using the encoding mode of the audio signal in each format to obtain the encoded signal parameter information of the audio signal in each format, the encoded signal parameter information of the audio signal in each format is written into the encoded stream and the encoded stream is sent to the decoding end. It can be seen that, in the embodiment of the disclosure, when encoding the audio signal in the mixed format (also called the mixed-format audio signal), the audio signals in different formats are reorganized and analyzed based on the characteristics of the audio signals in different formats, and for the audio signals in different formats, adaptive encoding modes are determined and then the corresponding encoding kernels are used for encoding, thereby achieving a better encoding efficiency.

Alternatively, in an embodiment of the disclosure, the apparatus is further configured to:
perform a code stream analysis on the encoded stream to obtain a classification side information parameter, a side information parameter corresponding to an audio signal in each format, and encoded signal parameter information of the audio signal in each format.

The classification side information parameter is configured to indicate a classification manner for a second type of object signal set of the object-based audio signal, and the side information parameter is configured to indicate an encoding mode corresponding to the audio signal in each format.

Alternatively, in an embodiment of the disclosure, the decoding module is further configured to:
decode encoded signal parameter information of the channel-based audio signal based on a side information parameter corresponding to the channel-based audio signal;
decode encoded signal parameter information of the object-based audio signal based on the classification side information parameter and a side information parameter corresponding to the object-based audio signal; and
decode encoded signal parameter information of the scene-based audio signal based on a side information parameter corresponding to the scene-based audio signal.

Alternatively, in an embodiment of the disclosure, the decoding module is further configured to:
determine, from the encoded signal parameter information of the object-based audio signal, encoded signal parameter information corresponding to a first type of object signal set and encoded signal parameter information corresponding to the second type of object signal set;
decode the encoded signal parameter information corresponding to the first type of object signal set based on a side information parameter corresponding to the first type of object signal set; and decode the encoded signal parameter information corresponding to the second type of object signal set based on the classification side information parameter and the side information parameter corresponding to the second type of object signal set.

Alternatively, in an embodiment of the disclosure, the decoding module is further configured to:
determine the classification manner for the second type of object signal set based on the classification side information parameter;
decode the encoded signal parameter information corresponding to the second type of object signal set based on the classification manner for the second type of object signal set and the side information parameter corresponding to the second type of object signal set.

Alternatively, in an embodiment of the disclosure, the classification side information parameter indicates that the classification manner for the second type of object signal set is based on cross-correlation parameter values; the decoding module is further configured to:
decode the encoded signal parameter information of all signals in the second type of object signal set using a same object signal decoding kernel based on the classification manner for the second type of object signal set and the side information parameter corresponding to the second type of object signal set.

Alternatively, in an embodiment of the disclosure, the classification side information parameter indicates that the classification manner for the second type of object signal set is based on a frequency-band bandwidth range; the decoding module is further configured to:
decode the encoded signal parameter information of different signals in the second type of object signal set using different object signal decoding kernels based on the classification manner for the second type of object signal set and the side information parameter corresponding to the second type of object signal set.

Alternatively, in an embodiment of the disclosure, the apparatus is further configured to:
perform post-processing on the decoded object-based audio signal.

Alternatively, in an embodiment of the disclosure, the decoding module is further configured to:
determine an encoding mode corresponding to the channel-based audio signal based on the side information parameter corresponding to the channel-based audio signal; and
decode the encoded signal parameter information of the channel-based audio signal using a corresponding decoding mode based on the encoding mode corresponding to the channel-based audio signal.

Alternatively, in an embodiment of the disclosure, the decoding module is further configured to:
determine an encoding mode corresponding to the scene-based audio signal based on the side information parameter corresponding to the scene-based audio signal; and
decode the encoded signal parameter information of the scene-based audio signal using a corresponding decoding mode based on the encoding mode corresponding to the scene-based audio signal.

FIG. 20 is a block diagram of a user equipment UE2000 according to an embodiment of the disclosure. The UE2000 may be a mobile phone, a computer, a digital broadcasting terminal, a message transceiver device, a game console, a tablet device, a medical device, a fitness device and a personal digital assistant, etc.

As illustrated in FIG. 20, the UE2000 may include one or more of the following components: a processing component 2002, a memory 2004, a power component 2006, a multimedia component 2008, an audio component 2010, an input/output (I/O) interface 2012, a sensor component 2013, and a communication component 2016.

The processing component 2002 typically controls overall operations of the UE2000, such as the operations associated with display, telephone calls, data communications, camera operations, and recording operations. The processing component 2002 may include one or more processors 2020 to execute instructions to implement all or part of the steps in the above described method for reporting location-related information. Moreover, the processing component 2002 may include one or more modules which facilitate the interaction between the processing component 2002 and other components. For example, the processing component 2002 may include a multimedia module to facilitate the interaction between the multimedia component 2008 and the processing component 2002.

The memory 2004 is configured to store various types of data to support the operation of the UE2000. Examples of such data include instructions for any applications or methods operated on the UE2000, contact data, phonebook data, messages, pictures, videos, etc. The memory 2004 may be implemented using any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

The power component 2006 provides power to various components of the UE2000. The power component 2006 may include a power management system, one or more power sources, and any other components associated with the generation, management, and distribution of power in the UE2000.

The multimedia component 2008 includes a screen providing an output interface between the UE2000 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensor may not only sense a boundary of a touch or swipe action, but also sense a period of time and a pressure associated with the touch or swipe action. In some embodiments, the multimedia component 2008 includes a front-facing camera and/or a rear-facing camera. When the UE2000 is in an operating mode, such as a shooting mode or a video mode, the front-facing camera and/or the rear-facing camera can receive external multimedia data. Each front-facing camera and rear-facing camera may be a fixed optical lens system or has a focal length and optical zoom capability.

The audio component 2010 is configured to output and/or input audio signals. For example, the audio component 2010 includes a microphone (MIC) configured to receive an external audio signal when the UE2000 is in an operation mode, such as a call mode, a recording mode, and a voice recognition mode. The received audio signal may be further stored in the memory 2004 or transmitted via the communication component 2016. In some embodiments, the audio component 2010 further includes a speaker to output audio signals.

The I/O interface 2012 provides an interface between the processing component 2002 and peripheral interface modules, such as a keyboard, a click wheel, buttons, and the like. The buttons may include, but are not limited to, a home button, a volume button, a starting button, and a locking button.

The sensor component 2013 includes one or more sensors to provide status assessments of various aspects of the UE2000. For instance, the sensor component 2013 may detect an open/closed status of the UE2000, relative positioning of components, e.g., the display and the keypad, of the UE2000, a change in position of the UE2000 or a component of the UE2000, a presence or absence of user contact with the UE2000, an orientation or an acceleration/deceleration of the UE2000, and a change in temperature of the UE2000. The sensor component 2013 may include a proximity sensor configured to detect the presence of nearby objects without any physical contact. The sensor component 2013 may also include a light sensor, such as a Complementary Metal Oxide Semiconductor (CMOS) or Charge-Coupled Device (CCD) image sensor, for use in imaging applications. In some embodiments, the sensor component 2013 may also include an accelerometer sensor, a gyroscope sensor, a magnetic sensor, a pressure sensor, or a temperature sensor.

The communication component 2016 is configured to facilitate communication, wired or wirelessly, between the UE2000 and other devices. The UE2000 can access a wireless network based on a communication standard, such as Wi-Fi, 2G or 3G, or a combination thereof. In an exemplary embodiment, the communication component 2016 receives a broadcast signal from an external broadcast management system or broadcast associated information via a broadcast channel. In an exemplary embodiment, the communication component 2016 further includes a Near Field Communication (NFC) module to facilitate short-range communication. For example, the NFC module may be implemented based on a RF Identification (RFID) technology, an Infrared Data Association (IrDA) technology, an Ultra-Wide Band (UWB) technology, a Blue Tooth (BT) technology, and other technologies.

In the exemplary embodiment, the UE2000 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, for performing the above method.

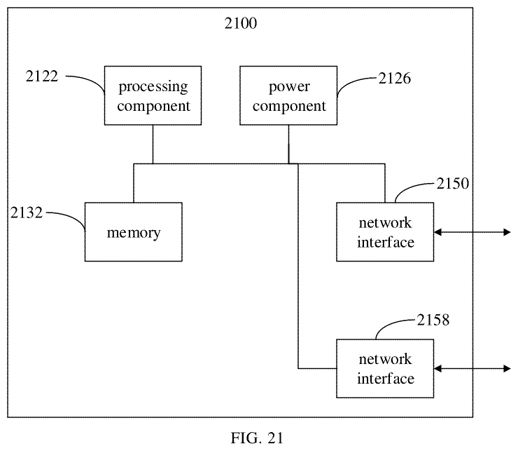

FIG. 21 is a block diagram of a network side device 2100 according to an embodiment of the disclosure. The network side device 2100 may be provided as a network side device. As illustrated in FIG. 21, the network side device 2100 includes a processing component 2111 consisting of one or more processors, and memory resources represented by a memory 2132 for storing instructions that may be executed by the processing component 2122, such as applications. The applications stored in the memory 2132 may include one or more modules each corresponding to a set of instructions. In addition, the processing component 2122 is configured to execute the instructions to implement the method applied to the network side device as described above, for example, the method illustrated in FIG. 1.

The network side device 2100 may also include a power component 2126 configured to perform power management of the network side device 2100, a wired or wireless network interface 2150 configured to connect the network side device 2100 to a network, and an input/output (I/O) interface 2158. The network side device 2100 may operate based on an operating system stored in the memory 2132, such as Windows Server™, Mac OS X™, Unix™, Linux™, FreeBSD™, or the like.

In the above embodiments of the disclosure, the methods according to the embodiments of the disclosure are described from the perspectives of the network side device and the UE, respectively. In order to realize each of the functions in the methods according to the above embodiments of the disclosure, the network side device and the UE may include a hardware structure, a software module, and realize each of the above functions in the form of hardware structure, software module, or a combination of hardware structure and software module. A certain function of the above functions may be performed in the form of hardware structure, software module, or a combination of hardware structure and software module.

An embodiment of the disclosure further provides a communication apparatus. The communication apparatus may include a transceiver module and a processing module. The transceiver module may include a sending module and/or a receiving module. The sending module is configured to implement a sending function. The receiving module is configured to implement a receiving function. The transceiver module may implement the sending function and/or the receiving function.

The communication apparatus may be a terminal device (such as the terminal device in the foregoing method embodiments), or may be an apparatus in the terminal device, or may be an apparatus capable of being used in combination with the terminal device. Alternatively, the communication apparatus may be a network device, or may be an apparatus in the network device, or may be an apparatus capable of being used in combination with the network device.

An embodiment of the disclosure further provides another communication apparatus. The communication apparatus may be a network device or a terminal device (such as the terminal device in the foregoing method embodiments), or may be a chip, a chip system or a processor that supports the network device to realize the above-described methods, or may be a chip, a chip system or a processor that supports the terminal device to realize the above-described methods. The apparatus may be used to realize the methods described in the above method embodiments with reference to the description of the above-described method embodiments.

The communication device may include one or more processors. The processor may be a general purpose processor or a dedicated processor, such as, a baseband processor and a central processor. The baseband processor is used for processing communication protocols and communication data. The central processor is used for controlling the communication apparatus (e.g., a base station, a baseband chip, a terminal device, a terminal device chip, a DU, or a CU), executing computer programs, and processing data of the computer programs.

Optionally, the communication apparatus may include one or more memories on which computer programs may be stored. The processor executes the computer programs to cause the communication apparatus to perform the methods described in the above method embodiments. Alternatively, the memory may also store data. The communication apparatus and the memory may be provided separately or may be integrated together.

Optionally, the communication apparatus may also include a transceiver and an antenna. The transceiver may be referred to as a transceiver unit, a transceiver machine, or a transceiver circuit, for realizing a transceiver function. The transceiver may include a receiver and a transmitter. The receiver may be referred to as a receiving machine or a receiving circuit, for realizing the receiving function. The transmitter may be referred to as a transmitter machine or a transmitting circuit, for realizing the transmitting function.

Optionally, the communication apparatus may also include one or more interface circuits. The interface circuits are used to receive code instructions and transmit them to the processor. The processor runs the code instructions to cause the communication apparatus 70 to perform the method described in the method embodiments.

The communication apparatus is the terminal device (such as the terminal device in the foregoing method embodiments): the processor is configured to perform the method illustrated in any of FIG. 1 to FIG. 4.

The communication apparatus is the network device, and the transceiver is configured to perform the method illustrated in any of FIG. 5 to FIG. 7.

In an implementation, the processor may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the processor may store a computer program. When the computer program runs on the processor, the communication apparatus is caused to perform the methods described in the method embodiments above. The computer program may be solidified in the processor, and in such case the processor may be implemented by hardware.

In an implementation, the communication apparatus may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the description of the above embodiments may be a network device or a terminal device (such as the terminal device in the foregoing method embodiments), but the scope of the communication apparatus described in the disclosure is not limited thereto, and the structure of the communication apparatus may not be limited. The communication apparatus may be a stand-alone device or may be part of a larger device. For example, the described communication apparatus may be:
(1) a stand-alone IC, a chip, a chip system or a subsystem;
(2) a collection of ICs including one or more ICs, optionally, the collection of ICs may also include storage components for storing data and computer programs;
(3) an ASIC, such as a modem;
(4) a module that can be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

The case where the communication apparatus may be a chip or a chip system is described with reference to the schematic structure of the chip. The chip includes a processor and an interface. There may be one or more processors, and there may be multiple interfaces.

Alternatively, the chip further includes a memory, and the memory is configured to store necessary computer programs and data.

It is understood by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of the embodiments of the disclosure.

The embodiments of the present disclosure further provide a system, in which the system includes a communication apparatus acting as a terminal device (such as the first terminal device in the foregoing method embodiments) and a communication apparatus acting as a network device in the foregoing embodiment, or the system include a communication apparatus acting as a terminal device (such as the first terminal device in the foregoing method embodiments) and a communication apparatus acting as a network device in the foregoing embodiment.

The present disclosure further provides a readable storage medium having stored thereon instructions that, when executed by a computer, the functions of any of the foregoing method embodiments are implemented.

The present disclosure further provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the disclosure is implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art can understand that the first, second, and other various numerical numbers involved in the disclosure are only described for the convenience of differentiation, and are not used to limit the scope of the embodiments of the disclosure, or used to indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

Other embodiments of the disclosure will be apparent to those skilled in the art from consideration of the specification and practice of the disclosure disclosed here. The disclosure is intended to cover any variations, usages, or adaptations of the embodiments of the disclosure following the general principles thereof and including such departures from the disclosure as come within known or customary practice in the art. It is intended that the specification and embodiments are considered as exemplary only, with a true scope and spirit of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

1. A signal encoding and decoding method, applied to performed by an encoding end, comprising:
obtaining an audio signal in a mixed format, wherein the audio signal in the mixed format comprises at least one format of a channel-based audio signal, an object-based audio signal, or a scene-based audio signal;
determining, based on signal characteristics of audio signals in different formats, an encoding mode of the audio signal in each format; and
encoding the audio signal in each format using the encoding mode of the audio signal in each format to obtain encoded signal parameter information of the audio signal in each format, writing the encoded signal parameter information of the audio signal in each format into an encoded stream and sending the encoded stream to a decoding end.

2. The method of claim 1, wherein determining, based on the signal characteristics of the audio signals in different formats, the encoding mode of the audio signal in each format comprises:
determining an encoding mode of the channel-based audio signal based on a signal characteristic of the channel-based audio signal;
determining an encoding mode of the object-based audio signal based on a signal characteristic of the object-based audio signal; and
determining an encoding mode of the scene-based audio signal based on a signal characteristic of the scene-based audio signal.

3. The method of claim 2, wherein determining the encoding mode of the channel-based audio signal based on the signal characteristic of the channel-based audio signal comprises:
obtaining a number of object signals included in the channel-based audio signal;
determining whether the number of the object signals included in the channel-based audio signal is less than a first threshold;
in response to the number of the object signals included in the channel-based audio signal being less than the first threshold, determining that the encoding mode of the channel-based audio signal is at least one of:
encoding each object signal in the channel-based audio signal using an object signal encoding kernel; or
obtaining input first command line control information, and encoding at least part of the object signals in the channel-based audio signal using the object signal encoding kernel based on the first command line control information, wherein the first command line control information is configured to indicate object signals that need to be encoded among the object signals included in the channel-based audio signal, and a number of the object signals that need to be encoded is greater than or equal to 1 and less than the number of the object signals included in the channel-based audio signal.

4. The method of claim 2, wherein determining the encoding mode of the channel-based audio signal based on the signal characteristic of the channel-based audio signal comprises:
obtaining a number of object signals included in the channel-based audio signal;
determining whether the number of the object signals included in the channel-based audio signal is less than a first threshold;
in response to the number of the object signals included in the channel-based audio signal being not less than the first threshold, determining that the encoding mode of the channel-based audio signal is at least one of:
converting the channel-based audio signal into a first audio signal in another format, and encoding the first audio signal in another format using an encoding kernel corresponding to the first audio signal in another format, wherein a number of channels of the first audio signal in another format is smaller than a number of channels of the channel-based audio signal;
obtaining input first command line control information, and encoding at least part of the object signals in the channel-based audio signal using an object signal encoding kernel based on the first command line control information, wherein the first command line control information is configured to indicate object signals that need to be encoded among the object signals included in the channel-based audio signal, and a number of the object signals that need to be encoded is greater than or equal to 1 and less than the number of the object signals included in the channel-based audio signal; or
obtaining input second command line control information, and encoding at least part of channel signals in the channel-based audio signal using the object signal encoding kernel based on the second command line control information, wherein the second command line control information is configured to indicate channel signals that need to be encoded among the channel signals included in the channel-based audio signal, and a number of the channel signals that need to be encoded is greater than or equal to 1 and less than a number of the channel signals included in the channel-based audio signal.

5. (canceled)

6. The method of claim 2, wherein determining the encoding mode of the object-based audio signal based on the signal characteristic of the object-based audio signal comprises:
performing a signal characteristic analysis on the object-based audio signal to obtain an analysis result;
performing a classification on the object-based audio signal to obtain a first type of object signal set and a second type of object signal set, wherein each of the first type of object signal set and the second type of object signal set comprises at least one object-based audio signal;
determining an encoding mode corresponding to the first type of object signal set; and
performing a classification on the second type of object signal set based on the analysis result to obtain at least one object signal subset, and determining an encoding mode corresponding to each object signal subset based on a classification result, wherein the object signal subset comprises at least one object-based audio signal.

7. The method of claim 6, wherein performing the classification on the object-based audio signal to obtain the first type of object signal set and the second type of object signal set comprises one of:
classifying one or more signals that need not to be individually operated and processed in the object-based audio signal into the first type of object signal set, and classifying remaining signals into the second type of object signal set; or
classifying one or more signals belonging to a background sound in the object-based audio signal into the first type of object signal set, and classifying remaining signals into the second type of object signal set.

8. The method of claim 7, wherein determining the encoding mode corresponding to the first type of object signal set comprises one of:
performing first pre-rendering processing on an object-based audio signal in the first type of object signal set, and encoding the signal after the first pre-rendering processing using a multi-channel encoding kernel, wherein [,] the first pre-rendering processing comprises: performing signal format conversion processing on an object-based audio signal to convert the object-based audio signal into a channel-based audio signal; or
performing second pre-rendering processing on an object-based audio signal in the first type of object signal set, and encoding the signal after the second pre-rendering processing using a high order ambisonics (HOA) encoding kernel, wherein the second pre-rendering processing comprises: performing signal format conversion processing on an object-based audio signal to convert the object-based audio signal into a scene-based audio signal.

9. (canceled)

10. (canceled)

11. The method of claim 6, wherein the first type of object signal set comprises a first object signal subset and a second object signal subset;
wherein performing the classification on the object-based audio signal to obtain the first type of object signal set and the second type of object signal set comprises:
classifying one or more signals that need not to be individually operated and processed in the object-based audio signal into the first object signal subset, classifying one or more signals belonging to a background sound in the object-based audio signal into the second object signal subset, and classifying remaining signals into the second type of object signal set.

12. The method of claim 11, wherein determining the encoding mode corresponding to the first type of object signal set comprises:
determining that an encoding mode corresponding to the first object signal subset in the first type of object signal set comprises: performing first pre-rendering processing on an object-based audio signal in the first object signal subset, and encoding the signal after the first pre-rendering processing using a multi-channel encoding kernel; wherein the first pre-rendering processing comprises: performing signal format conversion processing on an object-based audio signal to convert the object-based audio signal into a channel-based audio signal; and
determining that an encoding mode corresponding to the second object signal subset in the first type of object signal set comprises: performing second pre-rendering processing on an object-based audio signal in the second object signal subset, and encoding the signal after the second pre-rendering processing using an HOA encoding kernel; wherein the second pre-rendering processing comprises: performing signal format conversion processing on an object-based audio signal to convert the object-based audio signal into a scene-based audio signal.

13. The method of claim 8, wherein performing the signal characteristic analysis on the object-based audio signal to obtain the analysis result comprises:
performing high-pass filtering processing on object-based audio signals; and
performing a correlation analysis on the signals after the high-pass filtering processing to determine cross-correlation parameter values between the object-based audio signals.

14. The method of claim 13, wherein performing the classification on the second type of object signal set based on the analysis result to obtain at least one object signal subset, and determining the encoding mode corresponding to each object signal subset based on the classification result comprises:
setting a normalized correlation degree interval based on correlation degrees; and
performing the classification on the second type of object signal set based on the cross-correlation parameter values of the object-based audio signals and the normalized correlation degree interval to obtain the at least one object signal subset, and determining the corresponding encoding mode based on a correlation degree corresponding to the at least one object signal subset.

15. The method of claim 14, wherein the encoding mode corresponding to the object signal subset comprises an independent encoding mode or a joint encoding mode.

16. (canceled)

17. The method of claim 14, wherein encoding the audio signal in each format using the encoding mode of the audio signal in each format to obtain the encoded signal parameter information of the audio signal in each format comprises:
encoding the object-based audio signal using the encoding mode of the object-based audio signal;
wherein encoding the object-based audio signal using the encoding mode of the object-based audio signal comprises:
encoding one or more signals in the first type of object signal set using an encoding mode corresponding to the first type of object signal set; and
performing preprocessing on one or more object signal subsets in the second type of object signal set, and encoding all the object signal subsets after the preprocessing in the second type of object signal set using respective encoding modes and using a same object signal encoding kernel.

18. The method of claim 8, wherein performing the signal characteristic analysis on the object-based audio signal to obtain the analysis result comprises:
analyzing a frequency-band bandwidth range of the object object-based audio signal.

19. The method of claim 18, wherein performing the classification on the second type of object signal set based on the analysis result to obtain at least one object signal subset, and determining the encoding mode corresponding to each object signal subset based on the classification result comprises one of:
determining bandwidth intervals corresponding to different frequency-band bandwidths; performing the classification on the second type of object signal set to obtain the at least one object signal subset based on the frequency-band bandwidth range of the object-based audio signal and the bandwidth intervals corresponding to different frequency-band bandwidths, and determining a corresponding encoding mode based on a frequency-band bandwidth corresponding to the at least one object signal subset; or
obtaining input third command line control information, wherein the third command line control information is configured to indicate a frequency-band bandwidth range to be encoded corresponding to the object-based audio signal; and performing the classification on the second type of object signal set by combining the third command line control information and the analysis result to obtain the at least one object signal subset, and determining the encoding mode corresponding to each object signal subset based on the classification result.

20. (canceled)

21. The method of claim 18, wherein encoding the audio signal in each format using the encoding mode of the audio signal in each format to obtain the encoded signal parameter information of the audio signal in each format comprises:
encoding the object-based audio signal using the encoding mode of the object-based audio signal;
wherein encoding the object-based audio signal using the encoding mode of the object-based audio signal comprises:
encoding one or more signals in the first type of object signal set using the encoding mode corresponding to the first type of object signal set; and
performing preprocessing on object signal subsets in the second type of object signal set, and encoding different object signal subsets after the preprocessing using respective encoding modes and using different object signal encoding kernels.

22. The method of claim 2, wherein determining the encoding mode of the scene-based audio signal based on the signal characteristic of the scene-based audio signal comprises:
obtaining a number of object signals included in the scene-based audio signal;
determining whether the number of the object signals included in the scene-based audio signal is less than a second threshold;
in response to the number of the object signals included in the scene-based audio signal being less than the second threshold, determining that the encoding mode of the scene-based audio signal is at least one of:
encoding each object signal in the scene-based audio signal using an object signal encoding kernel; or
obtaining input fourth command line control information, and encoding at least part of the object signals in the scene-based audio signal using the object signal encoding kernel based on the fourth command line control information, wherein the fourth command line control information is configured to indicate object signals that need to be encoded among the object signals included in the scene-based audio signal, and a number of the object signals that need to be encoded is greater than or equal to 1 and less than the number of the object signals included in the scene-based audio signal.

23. The method according to claim 2, wherein determining the encoding mode of the scene-based audio signal based on the signal characteristic of the scene-based audio signal comprises:
obtaining a number of object signals included in the scene-based audio signal;
determining whether the number of the object signals included in the scene-based audio signal is less than a second threshold;
in response to the number of the object signals included in the scene-based audio signal being not less than the second threshold, determining that the encoding mode of the scene-based audio signal is at least one of:
converting the scene-based audio signal into a second audio signal in another format, and encoding the second audio signal in another format using a scene signal encoding kernel, wherein a number of channels of the second audio signal in another format is smaller than a number of channels of the scene-based audio signal; or
performing a low-order conversion on the scene-based audio signal to covert the scene-based audio signal to a scene-based audio signal with a lower order than a current order of the scene-based audio signal, and encoding the scene-based audio signal with the lower order using the scene signal encoding kernel.

24. (canceled)

25. The method of claim 4, wherein writing the encoded signal parameter information of the audio signal in each format into the encoded stream and sending the encoded stream to the decoding end comprises:
determining a classification side information parameter, wherein the classification side information parameter is configured to indicate a classification manner for the second type of object signal set;
determining a side information parameter corresponding to the audio signal in each format, wherein the side information parameter is configured to indicate the encoding mode corresponding to the audio signal in each format; and
performing code stream multiplexing on the classification side information parameter, the side information parameter corresponding to the audio signal in each format, and the encoded signal parameter information of the audio signal in each format to obtain the encoded stream, and sending the encoded stream to the decoding end.

26. A signal encoding and decoding method, applied to performed by a decoding end, comprising:
receiving an encoded stream sent by an encoding end; and
decoding the encoded stream to obtain an audio signal in a mixed format, wherein the audio signal in the mixed format comprises at least one format of a channel-based audio signal, an object-based audio signal, or a scene-based audio signal.

27-43. (canceled)
